(19) United States
(12) Patent Application Publication
(10) Pub. No.: US 2013/0294687 A1
(43) Pub. Date: Nov. 7, 2013

(54) IMAGE PROCESSING APPARATUS, IMAGE PROCESSING METHOD, AND PROGRAM

(71) Applicant: SONY CORPORATION, Tokyo (JP)

(72) Inventor: Koji Fujimiya, Kanagawa (JP)

(73) Assignee: Sony Corporation, Tokyo (JP)

(21) Appl. No.: 13/870,101

(22) Filed: Apr. 25, 2013

(30) Foreign Application Priority Data
May 1, 2012 (JP) 2012-104522

(51) Int. Cl. G06K 9/46

(52) U.S. Cl. CPC G06K 9/4604
USPC 382/165

(57) ABSTRACT

A pixel change amount calculation unit calculates first pixel change amounts and second pixel change amounts by using a pixel signal outputted by an image sensor. A boundary direction determination unit determines a boundary direction in which a boundary of adjacent pixels having pixel values largely different from each other is present by using information on the first pixel change amounts and the second pixel change amounts. An interpolation value calculation unit calculates an interpolation value corresponding to the boundary direction based on a result of the determination of the boundary direction determination unit. An interpolation processor interpolates a first color component into a target pixel including a second color component by using the interpolation value calculated in the interpolation value calculation unit.

### BACKGROUND

The present disclosure relates to an image processing apparatus, an image processing method, and a program, and more particularly to a technology of highly accurately interpolating an insufficient color component into each of pixels constituting an image obtained through a color filter.

In a single-plate imaging apparatus, a color filter is used for decomposing subject light obtained through a lens into, for example, three primary colors of R (red), G (green), and B (blue). One having a Bayer arrangement is often used as the color filter. The Bayer arrangement means that G-filters, to which a luminance signal contributes at a higher rate, are arranged in a checkerboard pattern and R- and B-filters are arranged in a grid pattern at the other portions as illustrated in FIG. 43. Data of only one color among R, G, and B is obtained in each pixel of the image sensor. Therefore, other colors not obtained in a pixel need to be interpolated by calculation using pixel values of pixels surrounding that pixel. Such interpolation processing is called “demosaic” or “demosaicing.”

In the Bayer arrangement illustrated in FIG. 43, the G-filters are provided at a rate twice the R- and B-filters, and the G-filters are arranged in a checkerboard pattern while the R- and B-pixels are arranged in a grid pattern. That is, pixels corresponding to G are different in reproduction range of pixels from pixels corresponding to R and B. Further, the difference in reproduction range contributes to generation of false color, particularly, in a contour portion of an image and the like. In order to equalize the reproduction ranges, it is necessary to insert R- and B-pixel values as interpolation values into positions at which the R- and B-pixels are lost, such that the R- and B-pixels has the same arrangement as that of the G-pixels. That is, the quality of an image largely depends on whether or not the G-pixels can appropriately be interpolated into the R- and B-pixels. As a method for inserting the G-pixels into the R- and B-pixels with high accuracy, for example, a method of performing interpolation considering directionality of an edge (boundary) of an image is known.

For example, Japanese Patent Application Laid-open No. 2007-037104 (hereinafter, referred to as Patent Document 1) describes a method as follows. Specifically, in the method, pixel values of pixels surrounding a target pixel are used to estimate a direction in which a boundary is present (hereinafter, referred to as “boundary direction”) and an interpolation value is calculated in a calculation method corresponding to the estimated direction. As an estimation method for the boundary direction, Patent Document 1 describes a method of determining whether or not each of 0°-, 90°-, 45°-, and 135°-directions is the boundary direction with a horizontal direction in an arrangement direction of pixels being set to 0°.

### SUMMARY

As the number of directions for determining the presence or absence of the boundary direction increases, the interpolation accuracy increases. However, when the number of directions for determining the presence or absence of the boundary direction is increased, for example, calculation of change amounts of pixel values for determining the presence or absence of the boundary direction needs to be performed the same times as the number of directions. Accordingly, the amount of calculation also increases.

In view of the above-mentioned circumstances, it is desirable to determine the presence or absence of a boundary with respect to various directions without significantly increasing the amount of calculation.

According to an embodiment of the present disclosure, there is provided an image processing apparatus including a pixel change amount calculation unit, a boundary direction determination unit, an interpolation value calculation unit, and an interpolation processor. The respective units of the image processing apparatus have the following configurations and functions. The pixel change amount calculation unit is configured to calculate first pixel change amounts and second pixel change amounts by using a pixel signal outputted by an image sensor configured to photoelectrically convert light passing through a color filter including first color filters and second color filters and output the light as the pixel signal. The first color filters each include a first color component and are arranged in a checkerboard pattern. The second color filters each include a second color component different from the first color component and are arranged at positions other than the positions at which the first color filters are arranged in the checkerboard pattern. The first pixel change amounts are change amounts of pixel values at least in a first estimated boundary direction, a second estimated boundary direction, and a third estimated boundary direction out of estimated boundary directions in each of which a boundary of adjacent pixels having pixel values largely different from each other is estimated to be present. The second pixel change amounts are change amounts of pixel values in directions perpendicular to the first to third estimated boundary directions. The first estimated boundary direction is a horizontal direction in an arrangement direction of the pixels. The second estimated boundary direction is a vertical direction in the arrangement direction of the pixels. The third estimated boundary direction extends in a line that almost halves an angle formed by the first estimated boundary direction and the second estimated boundary direction. The boundary direction determination unit is configured to determine a boundary direction in which the boundary is present by using information on the first pixel change amounts calculated in the first to third estimated boundary directions and the second pixel change amounts calculated in the directions perpendicular to the first to third estimated boundary directions. The interpolation value calculation unit is configured to calculate an interpolation value corresponding to the boundary direction based on a result of the determination of the boundary direction determination unit. The interpolation processor is configured to interpolate the first color component into a target pixel including the second color component by using the interpolation value calculated in the interpolation value calculation unit.

Further, according to another embodiment of the present disclosure, there is provided an image processing method as follows. First, first pixel change amounts and second pixel change amounts are calculated by using a pixel signal outputted by an image sensor configured to photoelectrically convert light passing through a color filter including first color filters and second color filters and output the light as the pixel signal. The first color filters each include a first color component and are arranged in a checkerboard pattern. The second color filters each include a second color component different from the first color component and are arranged at positions other than the positions at which the first color filters are arranged in the checkerboard pattern. The first pixel change amounts are change amounts of pixel values at least in a first estimated boundary direction, a second estimated boundary direction, and a third estimated boundary direction out of estimated boundary directions in each of which a boundary of adjacent pixels having pixel values largely different from each other is estimated to be present. The second pixel change amounts are change amounts of pixel values in directions perpendicular to the first to third estimated boundary directions. The first estimated boundary direction is a horizontal direction in an arrangement direction of the pixels. The second estimated boundary direction is a vertical direction in the arrangement direction of the pixels. The third estimated boundary direction extends in a line that almost halves an angle formed by the first estimated boundary direction and the second estimated boundary direction. Subsequently, a boundary direction in which the boundary is present is determined by using information on the calculated first pixel change amounts and the second pixel change amounts calculated in the directions perpendicular to the first to third estimated boundary directions. Subsequently, an interpolation value corresponding to the boundary direction is calculated based on a result of the determination. Subsequently, the first color component is interpolated into a target pixel including the second color component by using the calculated interpolation value.

Further, according to still another embodiment of the present disclosure, there is provided a program that causes a computer to execute as follows. First, first pixel change amounts and second pixel change amounts are calculated by using a pixel signal outputted by an image sensor configured to photoelectrically convert light passing through a color filter including first color filters and second color filters and output the light as the pixel signal. The first color filters each include a first color component and are arranged in a checkerboard pattern. The second color filters each include a second color component different from the first color component and are arranged at positions other than the positions at which the first color filters are arranged in the checkerboard pattern. The first pixel change amounts are change amounts of pixel values at least in a first estimated boundary direction, a second estimated boundary direction, and a third estimated boundary direction out of estimated boundary directions in each of which a boundary of adjacent pixels having pixel values largely different from each other is estimated to be present. The second pixel change amounts are change amounts of pixel values in directions perpendicular to the first to third estimated boundary directions. The first estimated boundary direction is a horizontal direction in an arrangement direction of the pixels. The second estimated boundary direction is a vertical direction in the arrangement direction of the pixels. The third estimated boundary direction extends in a line that almost halves an angle formed by the first estimated boundary direction and the second estimated boundary direction. Subsequently, a boundary direction in which the boundary is present is determined by using information on the calculated first pixel change amounts and the second pixel change amounts calculated in the directions perpendicular to the first to third estimated boundary directions. Subsequently, an interpolation value corresponding to the boundary direction is calculated based on a result of the determination. Subsequently, the first color component is interpolated into a target pixel including the second color component by using the calculated interpolation value.

With the above-mentioned configuration and processing, the boundary direction is determined based on information on the first pixel change amount and the second pixel change amount set based on the calculated pixel change amounts in the first to third estimated boundary directions. The boundary direction is determined based on the information on the first pixel change amount and the second pixel change amount. Thus, also if the boundary direction does not correspond to any one of the first to third estimated boundary directions in which the pixel change amounts have been calculated, it is possible to determine whether or not each of the first to third estimated boundary directions is the boundary direction.

According to the embodiments of the present disclosure, it is possible to reduce the amount of calculation of pixel change amounts and determine various boundary directions.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing an exemplary inner configuration of an imaging apparatus according to an embodiment of the present disclosure;

FIG. 2 is a block diagram showing an exemplary configuration of an interpolation processor according to the embodiment of the present disclosure;

FIG. 3 is an explanatory diagram showing a relationship between a boundary direction and a direction perpendicular to the boundary direction according to the embodiment of the present disclosure;

FIG. 4 is an explanatory diagram showing exemplary estimated boundary directions according to the embodiment of the present disclosure;

FIG. 5 is a flowchart showing exemplary processing of a pixel change amount calculation unit according to the embodiment of the present disclosure;

FIG. 6 is an explanatory diagram showing an exemplary pixel change amount calculation area in an estimated 0°-boundary direction according to the embodiment of the present disclosure;

FIGS. 7A and 7B are explanatory diagrams each showing exemplary pixel change amount calculation areas in directions perpendicular to an estimated boundary direction, regarding the estimated 0°-boundary direction according to the embodiment of the present disclosure;

FIGS. 8A and 8B are explanatory diagrams each showing exemplary pixel change amount calculation areas in directions perpendicular to an estimated boundary direction, regarding the estimated 0°-boundary direction according to the embodiment of the present disclosure;

FIG. 9 is an explanatory diagram showing an exemplary pixel change amount calculation area in an estimated 90°-boundary direction according to the embodiment of the present disclosure;

FIGS. 10A and 10B are explanatory diagrams each showing exemplary pixel change amount calculation areas in directions perpendicular to an estimated boundary direction, regarding the estimated 90°-boundary direction according to the embodiment of the present disclosure;

FIGS. 11A and 11B are explanatory diagrams each showing exemplary pixel change amount calculation areas in directions perpendicular to an estimated boundary direction, regarding the estimated 90°-boundary direction according to the embodiment of the present disclosure;

FIG. 12 is an explanatory diagram showing an exemplary pixel change amount calculation area in an estimated 45°-Boundary Direction according to the embodiment of the present disclosure;

FIGS. 13A and 13B are explanatory diagrams each showing exemplary pixel change amount calculation areas in the directions perpendicular to the estimated boundary direction, regarding the estimated 45°-boundary direction of according to the embodiment of the present disclosure;

FIGS. 14A and 14B are explanatory diagrams each showing exemplary pixel change amount calculation areas in directions perpendicular to an estimated boundary direction, regarding the estimated 45°-boundary direction of according to the embodiment of the present disclosure;

FIGS. 15A and 15B are explanatory diagrams each showing exemplary pixel change amount calculation areas in directions perpendicular to an estimated boundary direction, regarding the estimated 45°-boundary direction of according to the embodiment of the present disclosure;

FIG. 16 is an explanatory diagram showing an exemplary pixel change amount calculation area in an estimated 135°-Boundary Direction according to the embodiment of the present disclosure;

FIGS. 17A and 17B are explanatory diagrams each showing exemplary pixel change amount calculation areas in directions perpendicular to an estimated boundary direction, regarding the estimated 135°-boundary direction according to the embodiment of the present disclosure;

FIGS. 18A and 18B are explanatory diagrams each showing exemplary pixel change amount calculation areas in directions perpendicular to an estimated boundary direction, regarding the estimated 135°-boundary direction according to the embodiment of the present disclosure;

FIGS. 19A and 19B are explanatory diagrams each showing exemplary pixel change amount calculation areas in directions perpendicular to an estimated boundary direction, regarding the estimated 135°-boundary direction according to the embodiment of the present disclosure;

FIG. 20 is a flowchart showing exemplary processing by a boundary direction determination unit according to the embodiment of the present disclosure;

FIGS. 21A to 21C are explanatory diagrams showing exemplary relationships among a first direction, a second direction, and a third direction in the case where the boundary is in the estimated 0°-boundary direction according to the embodiment of the present disclosure, in which FIG. 21A shows a pixel change amount calculated in each estimated boundary direction, FIG. 21B shows a pixel change amount calculated in a direction perpendicular to each estimated boundary direction, and FIG. 21C shows position relationships among the first direction, the second direction, and the third direction;

FIG. 22 is a flowchart showing exemplary processing of the boundary direction determination unit according to the embodiment of the present disclosure;

FIG. 23 is a flowchart showing exemplary processing of the boundary direction determination unit according to the embodiment of the present disclosure;

FIGS. 24A and 24B are explanatory diagrams each showing a position relationship between each pixel and a boundary used for calculating an interpolation value in the case where the boundary is in a 45°-direction according to the embodiment of the present disclosure;

FIG. 25 is an explanatory diagram showing a position of each pixel used for calculating an interpolation value in the estimated 0°-boundary direction according to the embodiment of the present disclosure;

FIG. 26 is an explanatory diagram showing a position of each pixel used for calculating an interpolation value in the estimated 90°-boundary direction according to the embodiment of the present disclosure;

FIGS. 27A and 27B are explanatory diagrams each showing a position of each pixel used for calculating an interpolation value in the estimated 45°-boundary direction and a position relationship between each pixel and the boundary according to the embodiment of the present disclosure;

FIG. 28 is an explanatory diagram showing a position of each pixel used for calculating an interpolation value in the estimated 45°-boundary direction, a position relationship between each pixel and the boundary, and center-of-gravity correction directions according to the embodiment of the present disclosure;

FIGS. 29A and 29B are explanatory diagrams each showing a position relationship between each pixel and a boundary used for calculating an interpolation value in the case where the boundary is in a 135°-direction according to the embodiment of the present disclosure;

FIG. 30 is an explanatory diagram showing a position of each pixel used for calculating an interpolation value in the estimated 135°-boundary direction, a position relationship between each pixel and the boundary, and center-of-gravity correction directions according to the embodiment of the present disclosure;

FIG. 31 is an explanatory diagram showing a position of each pixel used for calculating an interpolation value in the estimated 30°-boundary direction, a position relationship between each pixel and the boundary, and center-of-gravity correction directions according to the embodiment of the present disclosure;

FIG. 32 is an explanatory diagram showing a position of each pixel used for calculating an interpolation value in an estimated 150°-boundary direction, a position relationship between each pixel and the boundary, and center-of-gravity correction directions according to the embodiment of the present disclosure;

FIG. 33 is an explanatory diagram showing a position of each pixel used for calculating an interpolation value in an estimated 60°-boundary direction, a position relationship between each pixel and the boundary, and center-of-gravity correction directions according to the embodiment of the present disclosure;

FIG. 34 is an explanatory diagram showing a position of each pixel used for calculating an interpolation value in an estimated 120°-boundary direction, a position relationship between each pixel and the boundary, and center-of-gravity correction directions according to the embodiment of the present disclosure;

FIG. 35 is a flowchart showing exemplary processing of the interpolation value calculation unit according to the embodiment of the present disclosure;

FIG. 36 is a flowchart showing exemplary processing of the interpolation processor according to the embodiment of the present disclosure;

FIG. 37 is an explanatory diagram showing each pixel used for calculating an interpolation value in the case where B is interpolated into a position at which R has been sampled according to the embodiment of the present disclosure;

FIG. 38 is an explanatory diagram showing each pixel used for calculating an interpolation value in the case where R is interpolated into a position at which B has been sampled according to the embodiment of the present disclosure;

FIG. 39 is an explanatory diagram showing each pixel used for calculating an interpolation value in the case where R is interpolated into a position at which G has been sampled according to the embodiment of the present disclosure;

FIG. 40 is an explanatory diagram showing each pixel used for calculating an interpolation value in the case where B is interpolated into a position at which G has been sampled according to the embodiment of the present disclosure;

FIG. 41 is an explanatory diagram showing an exemplary pixel change amount calculation area in the estimated 0°-boundary direction according to a modified example of the embodiment of the present disclosure;

FIG. 42 is an explanatory diagram showing exemplary pixel change amount calculation areas in directions perpendicular to the estimated 0°-boundary direction according to the embodiment of the present disclosure; and

FIG. 43 is an explanatory diagram showing an exemplary Bayer arrangement in related art.

### DETAILED DESCRIPTION OF EMBODIMENTS

Hereinafter, an exemplary image processing apparatus according to an embodiment of the present disclosure will be described with reference to the drawings in the following order. In this embodiment, an example in which an image processing apparatus according to an embodiment of the present disclosure is applied to an imaging apparatus will be described.

### 1. Exemplary Configuration of Imaging Apparatus

### 2. Exemplary Configuration of Interpolation Processor

### 3. Exemplary Color Interpolation Processing

### 4. Various Modified Examples

### 1. Exemplary Configuration of Imaging Apparatus

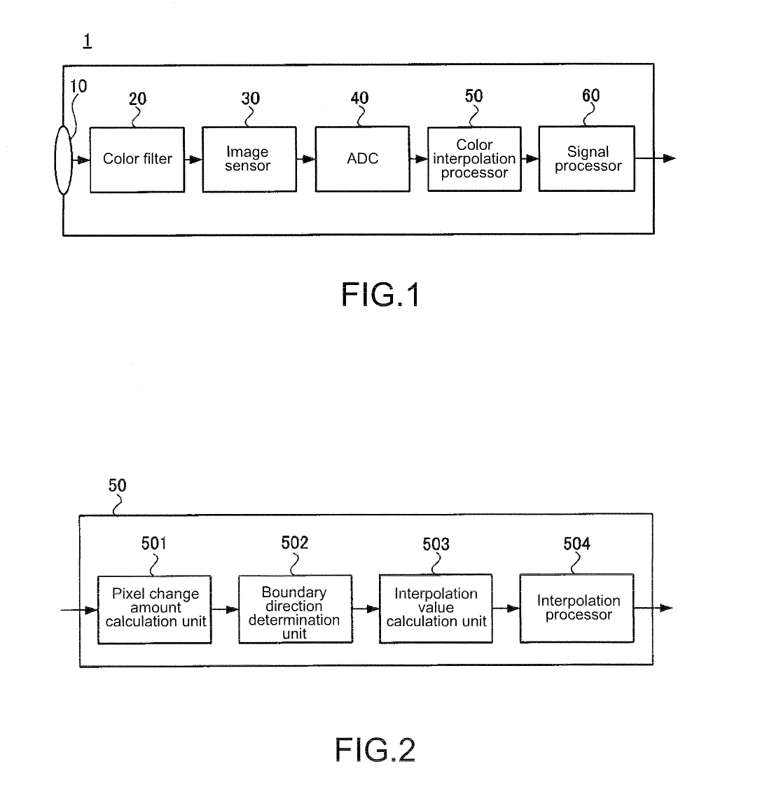

FIG. 1 shows an exemplary inner configuration of an imaging apparatus 1 to which the image processing apparatus according to the embodiment of the present disclosure is applied. The imaging apparatus 1 includes a lens 10, a color filter 20, an image sensor 30, an analog-to-digital converter 40 (hereinafter, referred to as ADC 40), a color interpolation processor 50, and a signal processor 60.

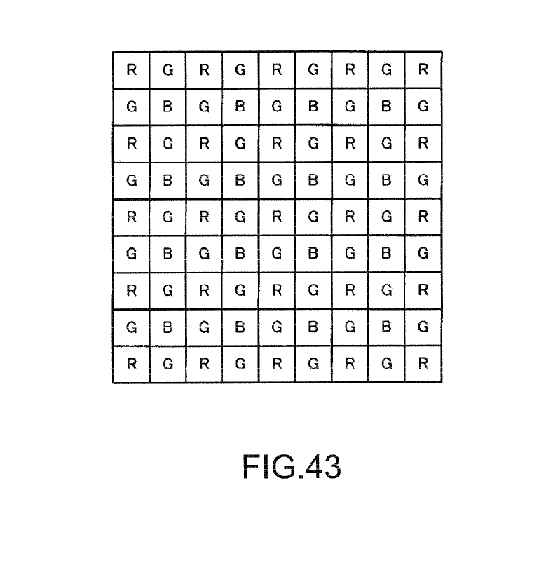

The lens 10 receives image light of a subject and forms an image in an imaging surface (not shown) of the image sensor 30. The color filter 20 is a Bayer arrangement filter as shown in FIG. 43. First color components “G” are arranged in a checkerboard pattern. Second or third color components “R” or “B” are arranged in a grid pattern at positions other than the positions at which the first color components “G” are arranged.

The image sensor 30 includes, for example, a charge coupled device (CCD) image sensor or a complementary metal oxide semiconductor (CMOS) image sensor. A plurality of photoelectric conversion elements corresponding to pixels are arranged in a two-dimensional manner in the image sensor 30. Each of the photoelectric conversion elements photoelectrically converts light passing through the color filter 20, and outputs the converted light as a pixel signal. Arrangement positions of R-, G-, and B-color filters (second color filter, first color filter, and third color filter, respectively) constituting the color filter 20 correspond to arrangement positions of the pixels of the image sensor 30. A pixel signal having any one color component of R (second color component), G (first color component), and B (third color component) is generated for each pixel.

The ADC 40 converts the pixel signal outputted from the image sensor 30 into a digital signal. The color interpolation processor 50 estimates each pixel signal converted by the ADC 40 into the digital signal. Specifically, the color interpolation processor 50 estimates color components not included in the pixel signal. Further, the color interpolation processor 50 performs processing of interpolating the estimated color components (demosaicing). Typically, in the demosaicing, the color interpolation processor 50 first performs processing of interpolating G into a position at which R or B has been sampled. Subsequently, the color interpolation processor 50 performs processing of interpolating B into a position at which R has been sampled and R into a position at which B has been sampled. The color interpolation processor 50 finally performs interpolation of R or B into a position at which G has been sampled.

The embodiment of the present disclosure has been made for the purpose of increasing the accuracy of the processing of interpolating G into the position at which R or B has been sampled as a first step. In order to increase the accuracy of the interpolation processing, if the color interpolation processor 50 determines that a boundary present in a portion including adjacent pixels having pixel values largely different from each other, for example, a contour portion of an object in an image passes through a target pixel, the color interpolation processor 50 performs interpolation processing corresponding to a direction in which the boundary is present. The processing of the color interpolation processor 50 will be described later in detail.

A signal processor 60 performs signal processing such as white-balance adjustment, gamma correction, and contour enhancement on the pixel signal subjected to the color interpolation processing by the color interpolation processor 50. Although the example in which the signal outputted from the color interpolation processor 50 is subjected to the white-balance adjustment and gamma correction, such processing may be performed at a stage previous to the color interpolation processor 50. When such processing is performed at the stage previous to the color interpolation processor 50, an excessively large luminance change between the adjacent pixels is overcome by signal processing. Thus, it is possible to further reduce false color caused due to the excessively large luminance change.

### 2. Exemplary Configuration of Color Interpolation Processor

Next, an exemplary configuration of the color interpolation processor 50 will be described with reference to FIG. 2. The color interpolation processor 50 includes a pixel change amount calculation unit 501, a boundary direction determination unit 502, an interpolation value calculation unit 503, and an interpolation processor 504. The pixel change amount calculation unit 501 calculates two kinds of change amounts of pixel values. One of the two kinds of change amounts of pixel values means change amounts of pixel values in each estimated boundary direction estimated as a direction in which the boundary is present. The other of the two kinds of change amounts of pixel values means change amounts of the pixel values in a direction perpendicular to each estimated boundary direction.

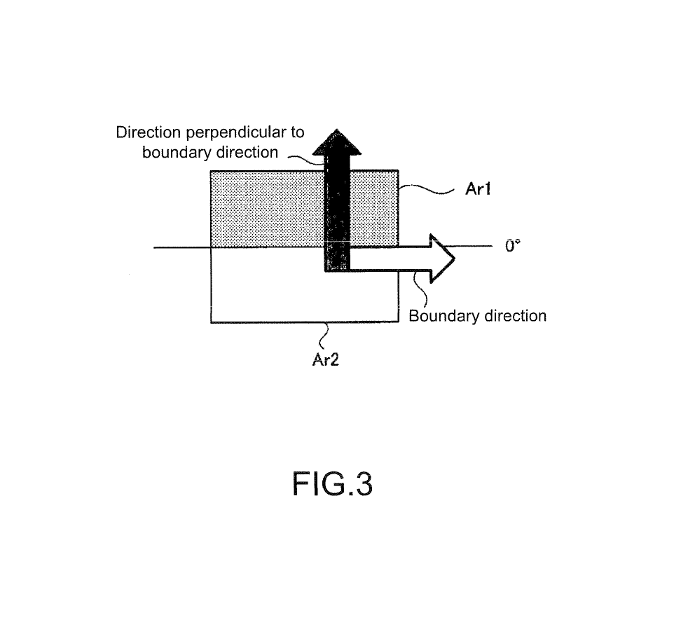

In the case where an area Ar1 and an area Ar2 having different shading (pixel value) of an image are present at a local area, the boundary direction means a direction along a boundary between the area Ar1 and the area Ar2 as shown in FIG. 3. In this embodiment, the change amount of the pixel value in the estimated boundary direction and the change amount of the pixel value in the direction perpendicular to each estimated boundary direction are used as a basis for determining which of the estimated boundary directions set in advance an actual boundary direction corresponds to.

If the boundary is present, a change amount of a pixel value between pixels located in the boundary direction is smallest among change amounts of pixel values in any direction other than the boundary direction. Further, a change amount of a pixel value between pixels located in the direction perpendicular to the boundary direction is largest among change amounts of pixel values in any direction other than the direction perpendicular to the boundary direction. That is, which of the directions set as the estimated boundary directions the actual boundary direction corresponds to can be determined by referring to magnitude relationships between the change amounts of the pixel values in the estimated boundary directions and the change amounts of the pixel values in the directions perpendicular to the estimated boundary directions.

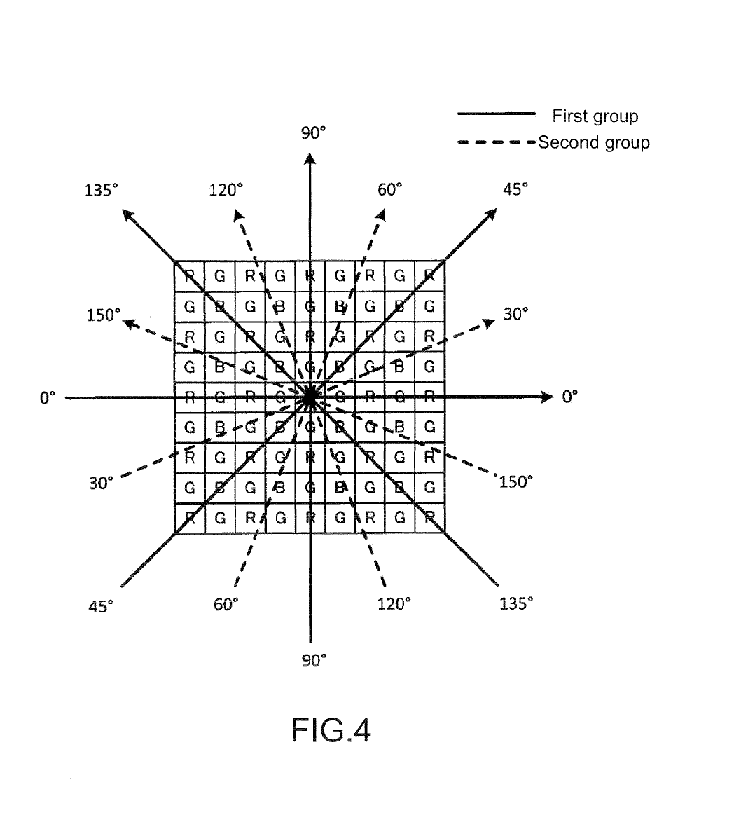

For example, eight directions are set as the estimated boundary directions in which the boundary is estimated to be present. FIG. 4 is a diagram showing the eight estimated boundary directions. Each of the estimated boundary directions is indicated by an angle with a horizontal direction of arrangement directions of pixels being set to 0°. The estimated boundary directions are classified into a first group and a second group. In the first group, the boundary direction is determined using calculation results of pixel change amounts. In the second group, the boundary direction is determined without calculating pixel change amounts. The first group includes 0° as a first estimated boundary direction, 90° as a second estimated boundary direction, and 45° and 135° as third estimated boundary directions. The second group includes 30°, 60°, 120°, and 150° as fourth estimated boundary directions. In FIG. 4, the first group is shown by solid lines and the second group is shown by dashed lines.

As described above, the pixel change amount calculation unit 501 calculates the change amount of the pixel value in each of the estimated boundary directions belonging to the first group. The pixel change amount calculation unit 501 does not calculate the change amount of the pixel value in each of the estimated boundary directions belonging to the second group.

The boundary direction determination unit 502 determines which of the eight estimated boundary directions the actual boundary corresponds to, based on the magnitude relationships between the change amounts of the pixel values in the estimated boundary directions and based on the change amounts of the pixel values in the directions perpendicular to the estimated boundary directions. More specifically, the boundary direction determination unit 502 determines which of the first group and the second group the boundary belongs to, or whether or not either one of the first group and the second group the boundary belongs to. The interpolation value calculation unit 503 changes an area in which a pixel used for calculating an interpolation value is to be selected or a calculation method for an interpolation value, corresponding to the estimated boundary direction determined by the boundary direction determination unit 502. The interpolation processor 504 uses the interpolation value calculated by the interpolation value calculation unit 503 to perform the interpolation processing on a target pixel Pi.

### 3. Exemplary Color Interpolation Processing

Next, exemplary processing by the respective units of the color interpolation processor 50 will be described later. Descriptions will be made in the following order.

### 3-1. Exemplary Processing of Pixel Change Amount Calculation Unit

### 3-2. Exemplary Processing of Boundary Direction Determination Unit and Interpolation Value Calculation Unit

### 3-3. Examples of Interpolation Value Calculation Method in Each Estimated Boundary Direction by Interpolation Value Calculation Unit

### 3-4. Exemplary Interpolation Processing of Color Component by Interpolation Value Calculation Unit

### [3-1. Exemplary Processing of Pixel Change Amount Calculation Unit]

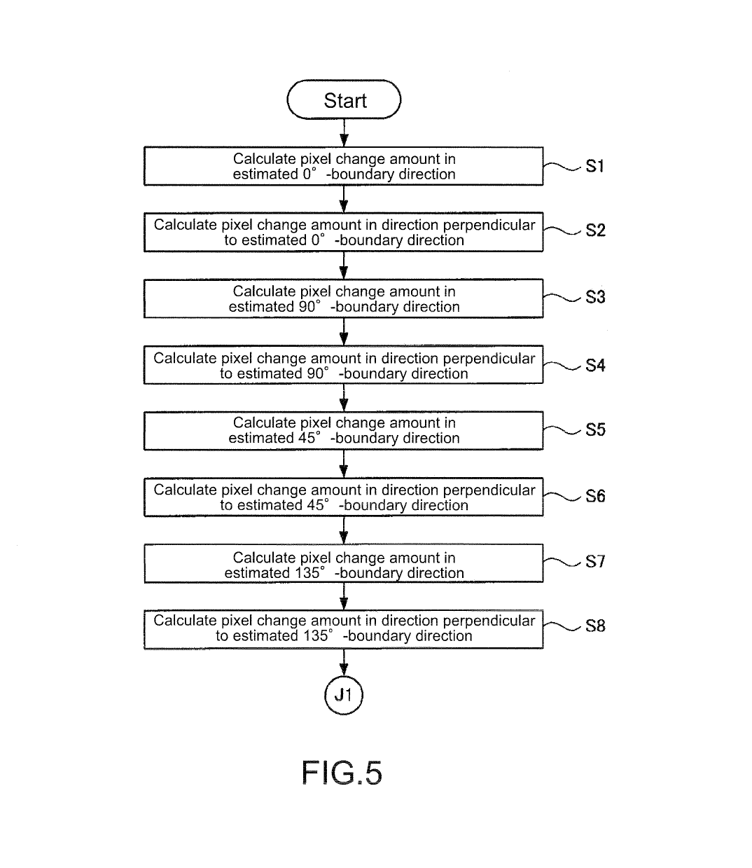

FIG. 5 is a flowchart showing exemplary processing by the pixel change amount calculation unit 501. The pixel change amount calculation unit 501 first calculates a change amount of a pixel value (hereinafter, also referred to as “pixel change amount”) in an estimated 0°-boundary direction (Step S1). The pixel change amount calculation unit 501 calculates a pixel change amount in a direction perpendicular to the estimated 0°-boundary direction (Step S2). Subsequently, the pixel change amount calculation unit 501 calculates a pixel change amount in an estimated 90°-boundary direction (Step S3). The pixel change amount calculation unit 501 calculates a pixel change amount in a direction perpendicular to the estimated 90°-boundary direction (Step S4). Subsequently, the pixel change amount calculation unit 501 calculates a pixel change amount in an estimated 45°-boundary direction (Step S5). The pixel change amount calculation unit 501 calculates a pixel change amount in a direction perpendicular to estimated 45°-boundary direction (Step S6). Subsequently, the pixel change amount calculation unit 501 calculates a pixel change amount in an estimated 135°-boundary direction (Step S7). The pixel change amount calculation unit 501 calculates a pixel change amount in a direction perpendicular to a direction perpendicular to estimated 135°-boundary direction (Step S8). The processing proceeds to a connector J1. Note that the calculation of the pixel change amounts in the estimated boundary directions does not necessarily need to be performed in the order shown in FIG. 5. Other order may be employed.

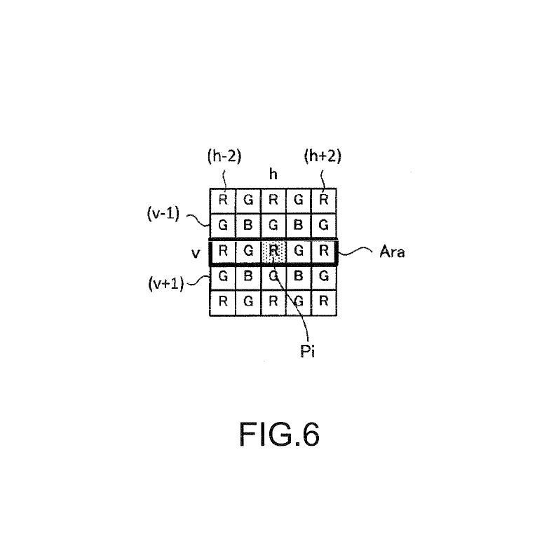

The pixel change amount is calculated by calculating a difference absolute value between pixel values of a plurality of pixels in a predetermined area set as a pixel change amount calculation area. FIG. 6 is a diagram showing a calculation area for the pixel value change amount (pixel change amount calculation area Ara) in the estimated 0°-boundary direction. In FIG. 6, a coordinate of the target pixel Pi in the horizontal direction is expressed by “h” and a coordinate in the vertical direction is expressed by “v”. Further, the pixel value of the target pixel Pi is denoted by, for example, a symbol R (h, v) in which a color component and coordinates of the target pixel Pi are combined. In the following description, a case where the target pixel Pi has an R-component. However, it should be noted that the same processing is performed if the target pixel Pi has a B-component.

### (3-1-1. Calculation Example for Pixel Change Amounts in Estimated 0°-Boundary Direction and Direction Perpendicular to Estimated 0°-Boundary Direction)

Regarding the estimated 0°-boundary direction, as shown in FIG. 6, for example, an area including five left and right pixels with the target pixel Pi being a center is set as the pixel change amount calculation area Ara. A difference absolute value between pixels having the same color component out of the pixels in the pixel change amount calculation area Ara is calculated. An average of the calculated difference absolute values is considered as the pixel change amount in the estimated 0°-boundary direction. When the pixel change amount in the estimated 0°-boundary direction is expressed by dif_along_{—}0 and an absolute-value generation function is expressed by abs( ), the pixel change amount dif_along_{—}0 can be calculated using Expression 1 below.

dif_along_{—}0=(abs(R(h−2,v)−R(h,v))+abs(G(h−1,v)−G(h+1,v))+abs(R(h,v)−R(h+2,v)))/3 Expression 1

That is, in Expression 1 above, difference absolute values are calculated in the following three combinations and an average of the difference absolute values is calculated.

(1) Difference between a pixel value R (h−2, v) of a pixel located at a position of (h−2, v) on a left-hand side out of pixels closest to the target pixel Pi in the estimated 0°-boundary direction and the pixel value R (h, v) of the target pixel Pi, the pixels each having an R-color component similar to the target pixel Pi
(2) Difference between a pixel value R (h+2, v) of a pixel located at a position of (h+2, v) on a right-hand side out of the pixels closest to the target pixel Pi in the estimated 0°-boundary direction and the pixel value R (h, v) of the target pixel Pi, the pixels each having an R-color component similar to the target pixel Pi
(3) Difference between a pixel value G (h−1, v) of a pixel located at a position of (h−1, v) adjacent, on a left-hand side, to the target pixel Pi and a pixel value G (h+1, v) of a pixel located at a position of (h+1, v) adjacent, on a right-hand side, to the target pixel Pi in the estimated 0°-boundary direction, each of which has a G-color component

Note that, in the calculation formula shown as Expression 1, the example in which the difference absolute values calculated in the three combinations are evenly averaged is shown. However, the present disclosure is not limited thereto. For example, weighted averaging may be performed. In this case, for example, a larger value is set as a weight for a pixel closer to the target pixel Pi.

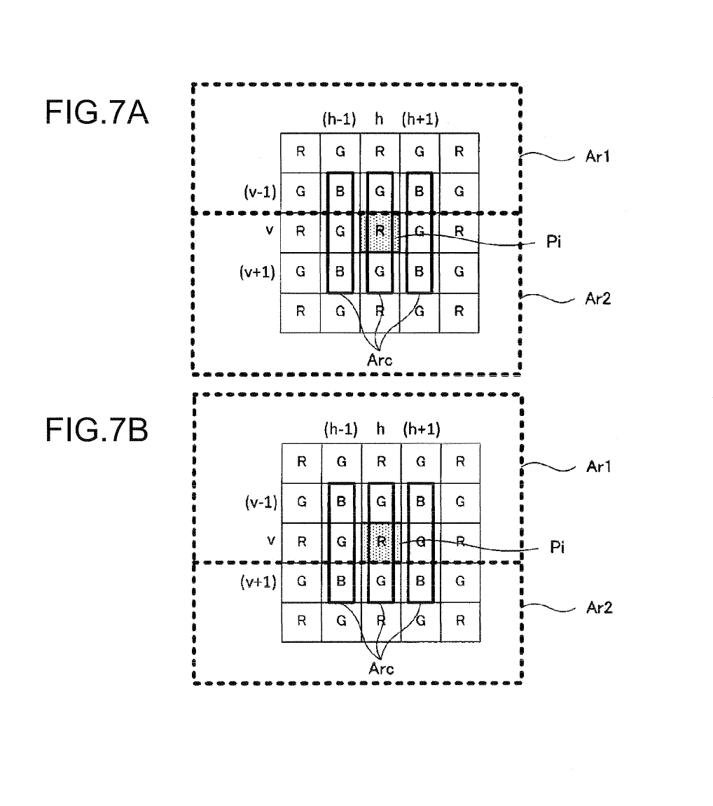

FIGS. 7A and 7B are diagrams each showing exemplary pixel change amount calculation areas Arc in the direction perpendicular to the estimated 0°-boundary direction. The pixel change amount in the direction perpendicular to the estimated boundary direction is determined by calculating a difference absolute value between pixels located in the direction perpendicular to the estimated 0°-boundary direction, that is, the estimated 90°-boundary direction. The number of pixels in the perpendicular direction for calculating the difference absolute value is set to, for example, two pixels on upper and lower sides sandwiching the target pixel Pi. That is, the difference absolute value between the pixel value of the pixel (h, v−1) and the pixel value of the pixel (h, v+1) is calculated.

Here, not only the difference absolute value between the pixels in the perpendicular direction that belongs to the same (h) as the target pixel Pi, but also a difference absolute value between pixels in the perpendicular direction in (h+1) on a right-hand side and a difference absolute value between pixels in the perpendicular direction in (h−1) on a left-hand side are calculated. Then, the calculated difference absolute values are averaged. In this manner, the boundary detection accuracy is increased.

Considering the target pixel Pi as a center, two positions of a 0°-direction boundary in the perpendicular direction can be assumed. Specifically, the position of the 0°-direction boundary in the perpendicular direction can be above or below the target pixel Pi. FIG. 7A shows the boundary passing above the target pixel Pi. On the other hand, FIG. 7B shows the boundary passing below the target pixel Pi. In the both figures, the boundaries are shown by dash lines. However, in either case, the pixel change amount calculation areas Arc have the same range.

Therefore, when the pixel change amount in the direction perpendicular to the estimated 0°-boundary direction is expressed by dif_cross_{—}0, the pixel change amount dif_cross_{—}0 can be calculated using Expression 2 below.

dif_cross_{—}0=(abs(B(h−1,v−1)−B(h−1,v+1))+abs(G(h,v−1)−G(h,v+1))+abs(B(h+1,v−1)−B(h+1,v+1)))/3 Expression 2

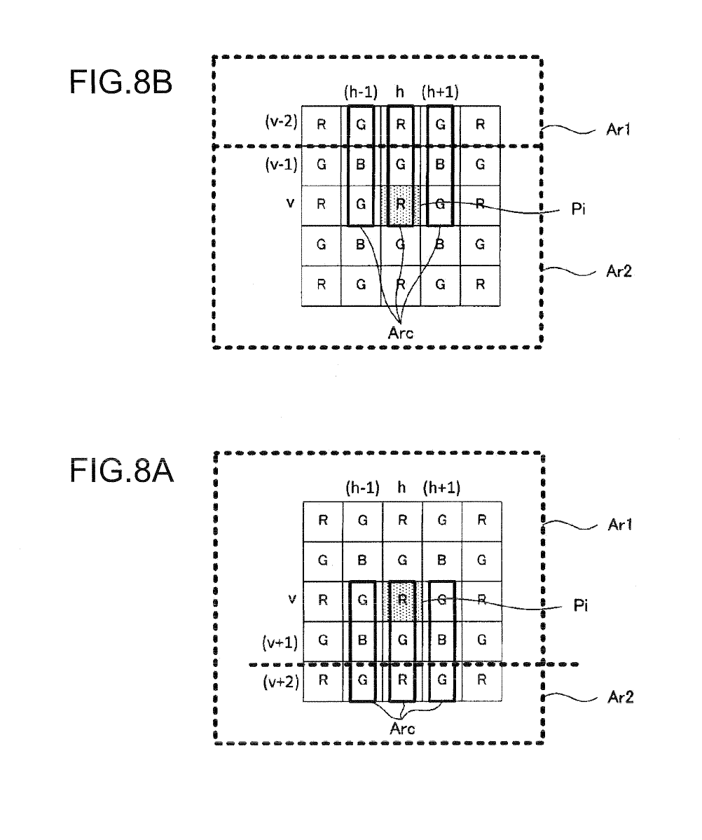

Note that the position of the 0°-direction boundary in the perpendicular direction can be between (v−2) and (v−1) as shown by a dashed line in FIG. 8A or between (v+2) and (v+1) by a dashed line in FIG. 8B. If the pixel change amount is calculated considering such a possibility, the boundary detection accuracy can be further increased. In this case, the difference absolute values in three areas are calculated. The three areas include the pixel change amount calculation areas Arc shown in FIG. 8A, the pixel change amount calculation areas Arc shown in FIG. 8B, and the pixel change amount calculation areas Arc shown in FIGS. 7A and 7B. Then, the maximum value among the difference absolute values is set as the pixel change amount in the direction perpendicular to the 0°-boundary direction.

In the example shown in FIG. 8A and the example shown in FIG. 8B, the pixel change amount calculation areas Arc are different. Thus, the pixel change amounts are respectively calculated in the two different sets of pixel change amount calculation areas Arc. When the pixel change amount in the pixel change amount calculation areas Arc shown in FIG. 8A is expressed by dif_cross_{—}0_n, the pixel change amount dif_cross_{—}0_n can be calculated using Expression 3 below.

dif_cross_{—}0_{—}n=(abs(G(h−1,v)−G(h−1,v−2))+abs(R(h,v)−R(h,v−2))+abs(G(h+1,v)−G(h+1,v−2)))/3 Expression 3

Further, when the pixel change amount in the pixel change amount calculation area Arc shown in FIG. 8B is expressed by dif_cross_{—}0_s, the pixel change amount dif_cross_{—}0_s can be calculated using Expression 4 below.

dif_cross_{—}0_{—}s=(abs(G(h−1,v)−G(h−1,v+2))+abs(R(h,v)−R(h,v+2))+abs(G(h+1,v)−G(h+1,v+2)))/3 Expression 4

When the pixel change amounts are calculated in the three pixel change amount calculation areas Arc different in position in the perpendicular direction as described above, one having a largest value among the pixel change amounts calculated in the three pixel change amount calculation areas Arc is set as the pixel change amount in the direction perpendicular to the 0°-boundary direction. When the pixel change amount in the direction perpendicular to the 0°-boundary direction is expressed by dif_cross_{—}0 and the pixel change amount in the pixel change amount calculation area Arc shown in FIGS. 7A and 7B is expressed by dif_cross_{—}0_v, the pixel change amount dif_cross_{—}0 can be calculated using Expression 5 below.

dif_cross_{—}0=MAX(dif_cross_{—}0_{—}v,dif_cross_{—}0_{—}n,dif_cross_{—}0_{—}s) Expression 5

### (3-1-2. Calculation Example for Pixel Change Amounts in Estimated 90°-Boundary Direction and Direction Perpendicular to Estimated 90°-Boundary Direction)

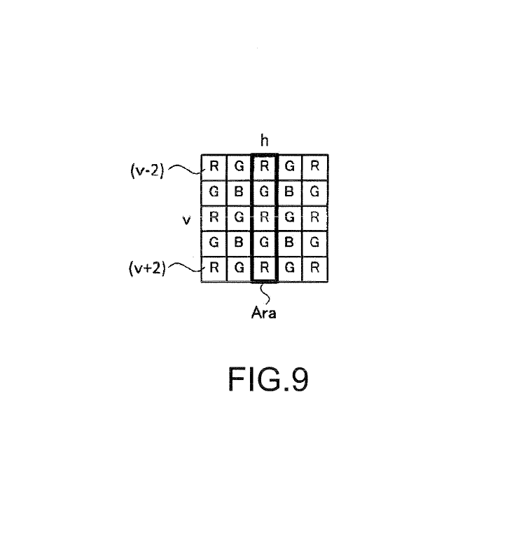

Regarding the estimated 90°-boundary direction, as shown in FIG. 9, for example, an area including five upper and lower pixels with the target pixel Pi being a center is set as the pixel change amount calculation area Ara. When the pixel change amount in the estimated 90°-boundary direction is expressed by dif_along_{—}90, the pixel change amount dif_along_{—}90 can be calculated using Expression 6 below.

dif_along_{—}90=(abs(R(h,v−2)−R(h,v))+abs(G(h,v−1)−G(h,v+1))+abs(R(h,v)−R(h,v+2)))/3 Expression 6

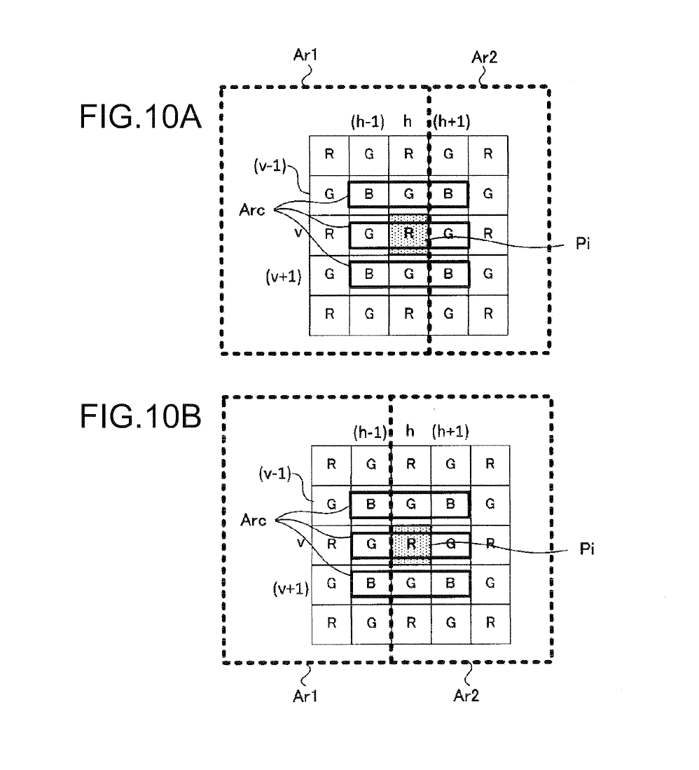

FIGS. 10A and 10B are diagrams each showing exemplary pixel change amount calculation areas Arc in the direction perpendicular to the estimated 90°-boundary direction. The pixel change amount in the direction perpendicular to the estimated boundary direction is determined by calculating a difference absolute value between pixels located in the direction perpendicular to the estimated 90°-boundary direction, that is, the estimated 0°-boundary direction. The number of pixels in the perpendicular direction for calculating the difference absolute value is set to, for example, two pixels on left- and right-hand sides sandwiching the target pixel Pi. That is, the difference absolute value between the pixel value of the pixel (h−1, v) and the pixel value of the pixel (h+1, v) is calculated.

Here, not only the difference absolute value between the pixels in the horizontal direction that belongs to the same (v) as the target pixel Pi, but also a difference absolute value between pixels in the horizontal direction in (v+1) on an upper side and a difference absolute value between pixels in the horizontal direction in (v−1) on a lower side are calculated. Then, the calculated difference absolute values are averaged.

Considering the target pixel Pi as a center, two positions of a 90°-direction boundary in the horizontal direction can be assumed. Specifically, the position of the 90°-direction boundary in the horizontal direction can be on a right-hand side or a left-hand side of the target pixel Pi. FIG. 10A shows the boundary passing on a right-hand side of the target pixel Pi. On the other hand, FIG. 10B shows the boundary passing on a left-hand side of the target pixel Pi. In the both figures, the boundaries are shown by dash lines. However, in either case, the pixel change amount calculation areas Arc have the same range.

Therefore, when the pixel change amount in the direction perpendicular to the estimated 900-boundary direction is expressed by dif_cross_{—}90, the pixel change amount dif_cross_{—}90 can be calculated using Expression 7 below.

dif_cross_{—}90=(abs(B(h−1,v−1)−B(h+1,v−1))+abs(G(h−1,v)−G(h+1,v))+abs(B(h−1,v+1)−B(h+1,v+1)))/3 Expression 7

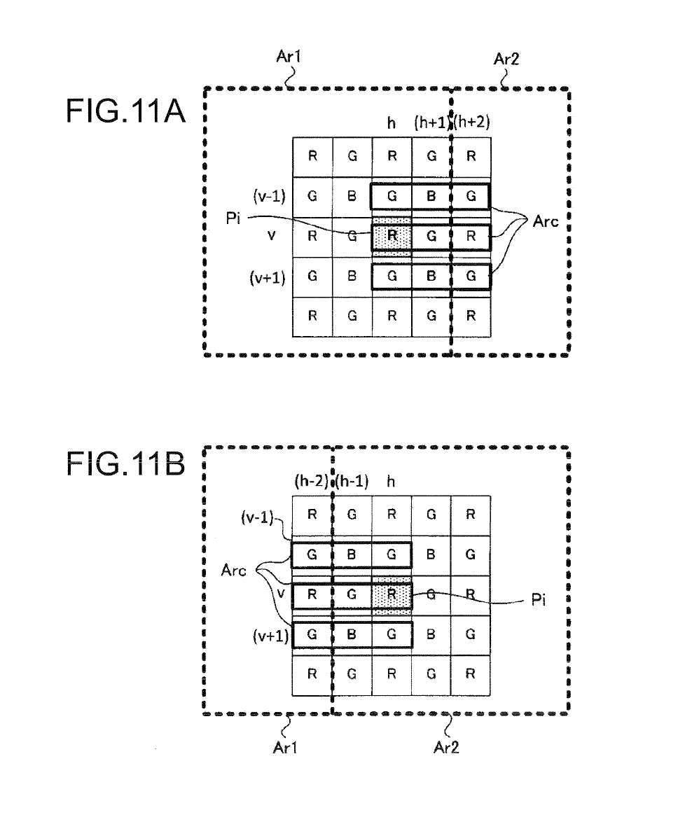

Note that the position of the 90°-direction boundary in the perpendicular direction can be between (h+1) and (h+2) as shown by a dashed line in FIG. 11A or between (h−2) and (h−1) as shown by a dashed line in FIG. 11B. If the pixel change amount is calculated considering such a possibility, the boundary detection accuracy can be further increased. In this case, the difference absolute values in three areas are calculated. The three areas include the pixel change amount calculation areas Arc shown in FIGS. 10A and 10B, the pixel change amount calculation areas Arc shown in FIG. 11A, and the pixel change amount calculation areas Arc shown in FIG. 11B. Then, the maximum value among the difference absolute values is set as the pixel change amount in the direction perpendicular to the 90°-boundary direction.

In the example shown in FIG. 11A and the example shown in FIG. 11B, the pixel change amount calculation areas Arc are different. Thus, the pixel change amounts are respectively calculated in the two different sets of pixel change amount calculation areas Arc. When the pixel change amount in the pixel change amount calculation areas Arc shown in FIG. 11A is expressed by dif_cross_{—}90_e, the pixel change amount dif_cross_{—}90_e can be calculated using Expression 8 below.

dif_cross_{—}90_{—}e=(abs(G(h,v−1)−G(h+2,v−1))+abs(R(h,v)−R(h+2,v))+abs(G(h,v+1)−G(h+2,v+1)))/3 Expression 8

Further, when the pixel change amount in the pixel change amount calculation area Arc shown in FIG. 11B is expressed by dif_cross_{—}90_w, the pixel change amount dif_cross_{—}90_w can be calculated using Expression 9 below.

dif_cross_{—}90_{—}w=(abs(G(h,v−1)−G(h−2,v−1))+abs(R(h,v)−R(h−2,v))+abs(G(h,v+1)−G(h−2,v+1)))/3 Expression 9

Then, when the pixel change amounts are calculated in the three pixel change amount calculation areas Arc different in the position in the horizontal direction, one having a largest value among the pixel change amounts calculated in the three pixel change amount calculation areas Arc is set as the pixel change amount in the direction perpendicular to the 90°-boundary direction. When the pixel change amount in the direction perpendicular to the 90°-boundary direction is expressed by dif_cross_{—}90 and the pixel change amount in the pixel change amount calculation areas Arc shown in FIGS. 10A and 10B is expressed by dif_cross_{—}90_h, the pixel change amount dif_cross_{—}90 can be calculated using Expression 10 below.

dif_cross_{—}90=MAX(dif_cross_{—}90_{—}h,dif_cross_{—}90_{—}e,dif_cross_{—}90_{—}w) Expression 10

### (3-1-3. Calculation Example for Pixel Change Amounts in Estimated 45°-Boundary Direction and Direction Perpendicular to Estimated 45°-Boundary Direction)

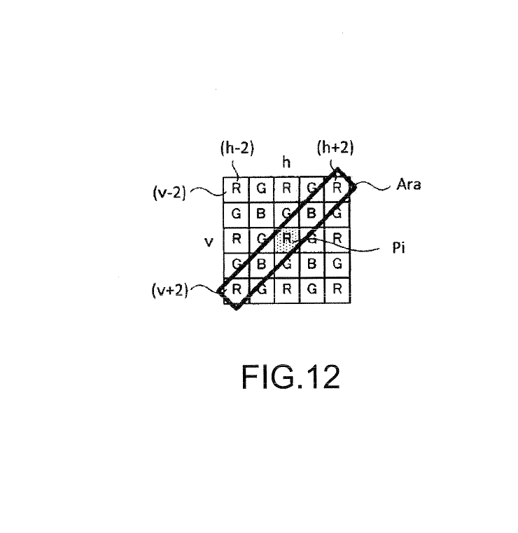

Regarding the estimated 45°-boundary direction, as shown in FIG. 12, for example, an area including five diagonally right up pixels with the target pixel Pi being a center is set as the pixel change amount calculation area Ara. When the pixel change amount in the estimated 45°-boundary direction is expressed by dif_along_{—}45, the pixel change amount dif_along_{—}45 can be calculated using Expression 11 below.

dif_along_{—}45=(abs(R(h−2,v+2)−R(h,v))+abs(B(h−1,v+1)−B(h+1,v−1))+abs(R(h,v)−R(h+2,v−2)))/3 Expression 11

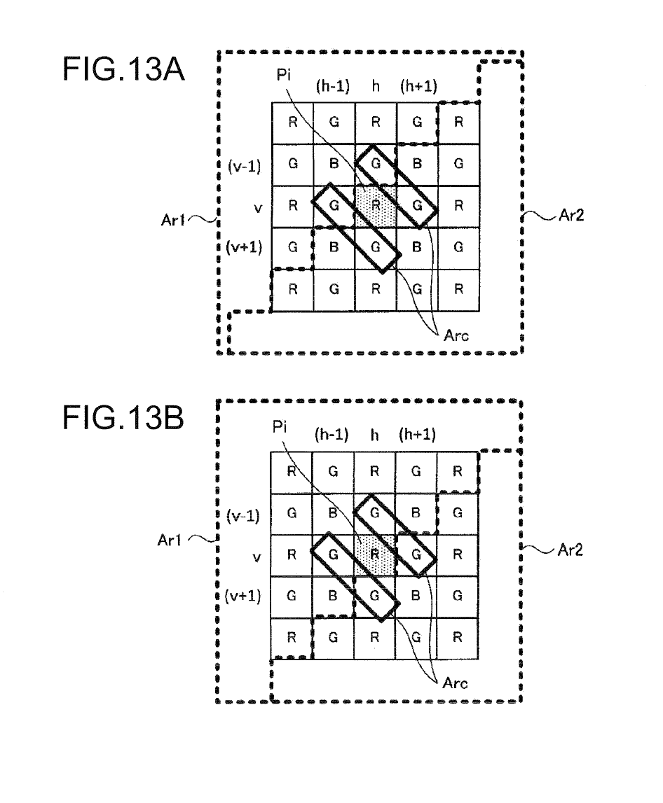

FIGS. 13A and 13B are diagrams each showing exemplary pixel change amount calculation areas Arc in the direction perpendicular to the estimated 45°-boundary direction. The pixel change amount in the direction perpendicular to the estimated boundary direction is determined by calculating a difference absolute value between pixels located in the direction perpendicular to the estimated 45°-boundary direction, that is, the estimated 135°-boundary direction. Here, difference absolute values are calculated in a combination of an upper pixel and a right neighbor pixel of the target pixel Pi and a combination of a left neighbor pixel and a lower pixel of the target pixel Pi out of the pixels located in the 135°-direction. An average of the difference absolute values is set as the pixel change amount in the direction perpendicular to the estimated 45°-boundary direction.

Considering the target pixel Pi as a center, two positions of a 45°-direction boundary in the 135°-direction can be assumed. Specifically, the position of the 45°-direction boundary in the 135°-direction can be on an upper left-hand side or a lower right-hand side of the target pixel Pi. FIG. 13A shows the boundary passing on the upper left-hand side of the target pixel Pi. On the other hand, FIG. 13B shows the boundary passing on the lower right-hand side of the target pixel Pi. In the both figures, the boundaries are shown by dash lines. However, in either case, the pixel change amount calculation areas Arc have the same range.

Therefore, when the pixel change amount in the direction perpendicular to the estimated 45°-boundary direction is expressed by dif_cross_{—}45, the pixel change amount dif_cross_{—}45 can be calculated using Expression 12 below.

dif_cross_{—}45=(abs(G(h−1,v)−G(h,v+1))+abs(G(h,v−1)−G(h+1,v)))/2 Expression 12

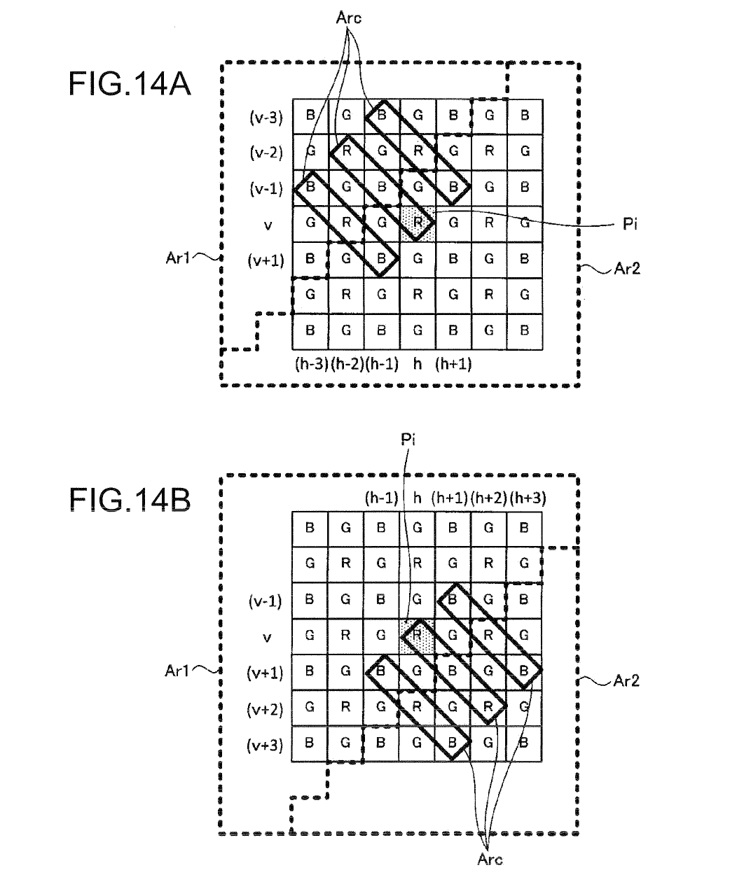

Note that the position of the 45°-direction boundary in the 135°-direction can be a position passing through an upper left corner of the target pixel Pi as shown by a dashed line in FIG. 14A or a position passing through a lower right corner of the target pixel Pi as shown by a dashed line in FIG. 14B. If the pixel change amount is calculated considering such a possibility, the boundary detection accuracy can be further increased.

In this case, the difference absolute values in the pixel change amount calculation areas Arc shown in FIGS. 14A and 14B are calculated. The pixel change amount calculation areas Arc shown in FIG. 14A include a line constituted of three pixels arranged in the 135°-direction from a position of B on an upper right-hand side of the target pixel Pi, a line constituted of three pixels arranged in the 135°-direction from a position of the target pixel Pi, and a line constituted of three pixels arranged in the 135°-direction from the position of B on a lower left-hand side of the target pixel Pi. The pixel change amount calculation areas Arc shown in FIG. 14B include a line constituted of three pixels arranged in the 135°-direction from a position of B on the upper right-hand side of the target pixel Pi, a line constituted of three pixels arranged in the 135°-direction from a position of the target pixel Pi, and a line constituted of three pixels arranged in the 135°-direction from the position of B on the lower left-hand side of the target pixel Pi. That is, the pixel change amount calculation area Arc shown in FIG. 14A includes the target pixel Pi in a lower right portion thereof in the 135°-direction. The pixel change amount calculation area Arc shown in FIG. 14B includes the target pixel Pi in an upper left portion thereof. Further, it is characterized in that the pixel change amount calculation areas Arc shown in both FIGS. 14A and 14B are the three lines for calculating the pixel change amount.

When the pixel change amount in the pixel change amount calculation areas Arc shown in FIG. 14A is expressed by dif_cross_{—}45_nw, the pixel change amount dif_cross_{—}45_nw can be calculated using Expression 13 below.

dif_cross_{—}45_{—}nw=(abs(B(h−1,v+1)−B(h−3,v−1))+abs(R(h,v)−R(h−2,v−2))+abs(B(h+1,v−1)−B(h−1,v−3)))/3 Expression 13

Further, when the pixel change amount in the pixel change amount calculation areas Arc shown in FIG. 14B is expressed by dif_cross_{—}45_se, the pixel change amount dif_cross_{—}45_se can be calculated using Expression 14 below.

dif_cross_{—}45_{—}se=(abs(B(h−1,v+1)−B(h+1,v+3))+abs(R(h,v)−R(h+2,v+2))+abs(B(h+1,v−1)−B(h+3,v+1)))/3 Expression 14

That is, in Expressions 13 and 14, calculation in which an average value of the difference absolute values obtained in the three lines for calculating the pixel change amount is used as the pixel change amount in the pixel change amount calculation areas Arc is performed. Then, out of the pixel change amount dif_cross_{—}45_nw in the pixel change amount calculation areas Arc shown in FIG. 14A and the pixel change amount dif_cross_{—}45_se in the pixel change amount calculation areas Arc shown in FIG. 14B, one having a larger value is set as the pixel change amount dif_cross_{—}45 in the direction perpendicular to the 45°-boundary direction. The pixel change amount dif_cross_{—}45 can be calculated using Expression 15 below.

dif_cross_{—}45=MAX(dif_cross_{—}45_{—}nw,dif_cross_{—}45_{—}se) Expression 15

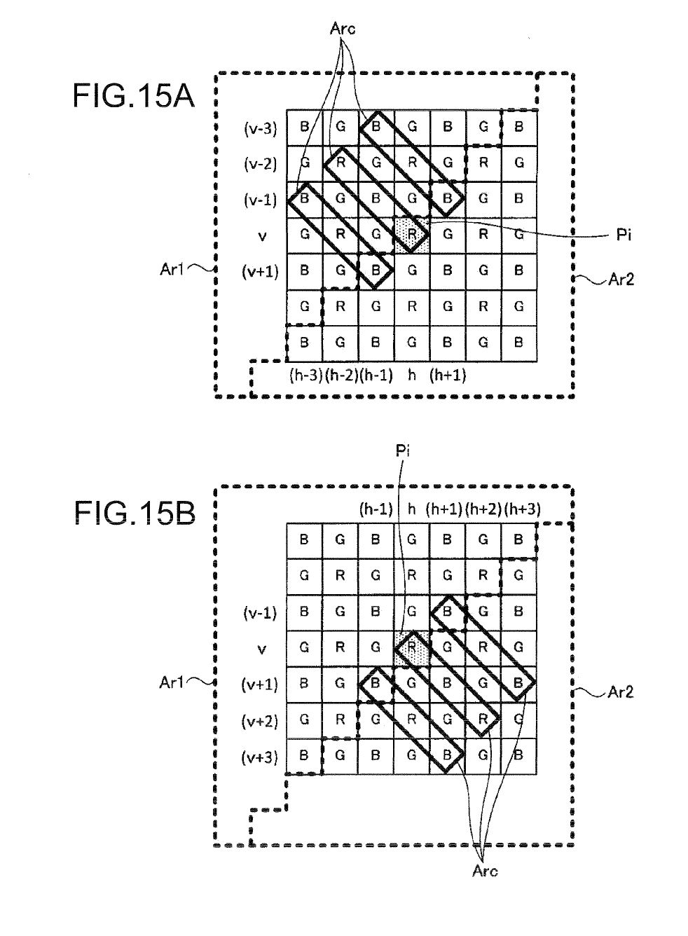

In this manner, the positions of the pixel change amount calculation areas Arc are set to the position including the target pixel Pi in the lower right portion thereof and the position including the target pixel Pi in the upper left portion thereof. Thus, it is possible to address both cases where the boundary passes on the upper left-hand side and the lower right-hand side of the target pixel Pi. FIG. 15A shows an example of the case where the boundary passes on the upper left-hand side of the target pixel Pi. FIG. 15B shows an example of the case where the boundary passes on the lower right-hand side of the target pixel Pi. The positions of the pixel change amount calculation areas Arc shown in FIG. 15A are the same as those shown in FIG. 14A. The positions of the pixel change amount calculation areas Arc shown in FIG. 15B are the same as those shown in FIG. 14B. As can be seen in FIGS. 15A and 15B, the boundary denoted by the dashed line is included in the pixel change amount calculation areas Arc the same as those shown in FIGS. 14A and 14B.

That is, by setting the pixel change amount calculation areas Arc at the positions shown in FIG. 14A (FIG. 15A) and the positions shown in FIG. 14B (FIG. 15B), the pixel change amount calculation areas Arc include all the boundaries passing through the upper left corner and the lower right corner and passing on the upper left-hand side and on the lower right-hand side of the target pixel Pi. As compared to a case where the pixel change amount is calculated with the pixel change amount calculation areas Arc shown in FIGS. 13A and 13B being targets (using Expression 12), the amount of calculation is increased. However, the positions of the boundaries to cover are increased, and hence the calculated pixel change amount dif_cross_{—}45 is made more suitable for an image.

### (3-1-4. Calculation Example for Pixel Change Amounts in Estimated 135°-Boundary Direction and Direction Perpendicular to Estimated 135°-Boundary Direction)

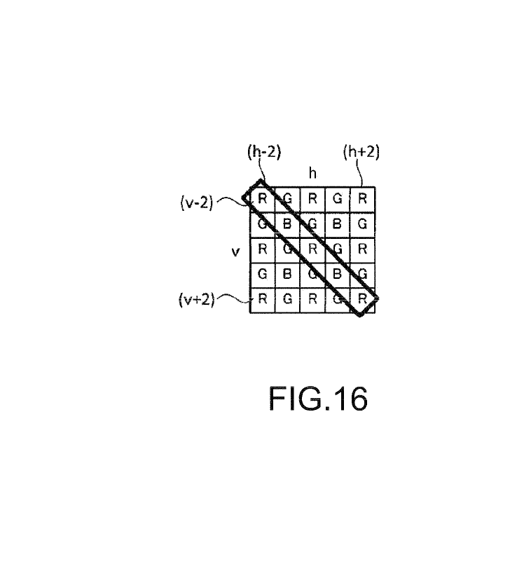

Regarding the estimated 135°-boundary direction, as shown in FIG. 16, for example, an area including five diagonally left up pixels with the target pixel Pi being a center is set as the pixel change amount calculation area Ara. When the pixel change amount in the estimated 135°-boundary direction is expressed by dif_along_{—}135, the pixel change amount dif_along_{—}135 can be calculated using Expression 16 below.

dif_along_{—}135=(abs(R(h−2,v−2)−R(h,v))+abs(B(h−1,v−1)−B(h+1,v+1))+abs(R(h,v)−R(h+2,v+2)))/3 Expression 16

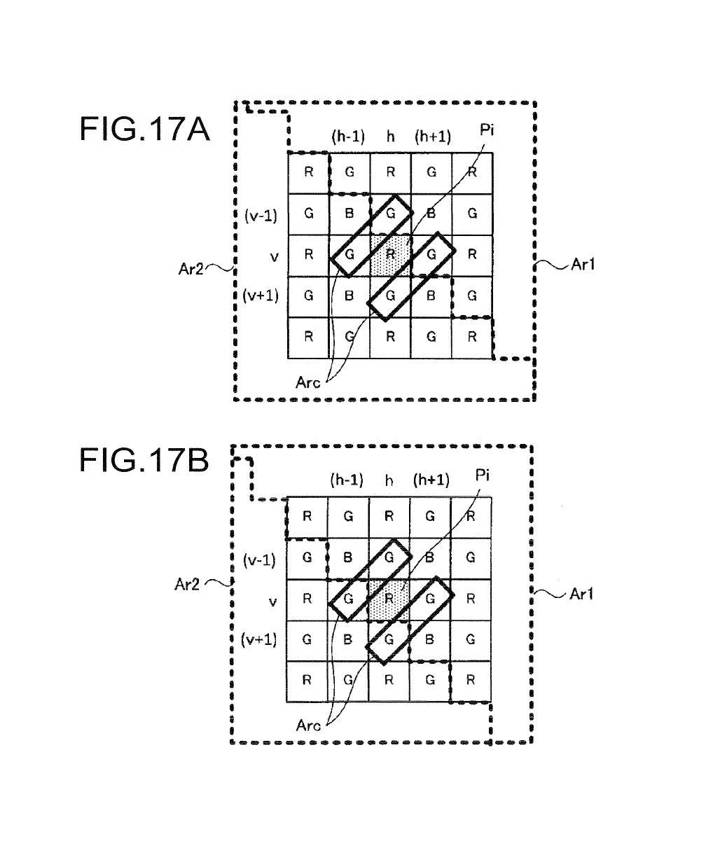

FIGS. 17A and 17B are diagrams each showing exemplary pixel change amount calculation areas Arc in the direction perpendicular to the estimated 135°-boundary direction. The pixel change amount in the direction perpendicular to the estimated boundary direction is determined by calculating a difference absolute value between pixels located in the direction perpendicular to the estimated 135°-boundary direction, that is, the estimated 45°-boundary direction. Here, difference absolute values are calculated in a combination of an upper pixel and a left neighbor pixel of the target pixel Pi and a combination of a right neighbor pixel and a lower pixel of the target pixel Pi out of the pixels located in the 135°-direction. An average of the difference absolute values is set as the pixel change amount in the direction perpendicular to the estimated 135°-boundary direction.

Considering the target pixel Pi as a center, two positions of a 135°-direction boundary in the 45°-direction can be assumed. Specifically, the position of the 135°-direction boundary in the 45°-direction can be on an upper right-hand side or a lower left-hand side of the target pixel Pi. FIG. 17A shows the boundary passing on the upper right-hand side of the target pixel Pi. On the other hand, FIG. 17B shows the boundary passing on the lower left-hand side of the target pixel Pi. In the both figures, the boundaries are shown by dash lines. However, in either case, the pixel change amount calculation areas Arc have the same range.

Therefore, when the pixel change amount in the direction perpendicular to the estimated 135°-boundary direction is expressed by dif_cross_{—}135, the pixel change amount dif_cross_{—}135 can be calculated using Expression 17 below.

dif_cross_{—}135=(abs(G(h−1,v)−G(h,v−1))+abs(G(h,v+1)−G(h+1,v)))/2 Expression 17

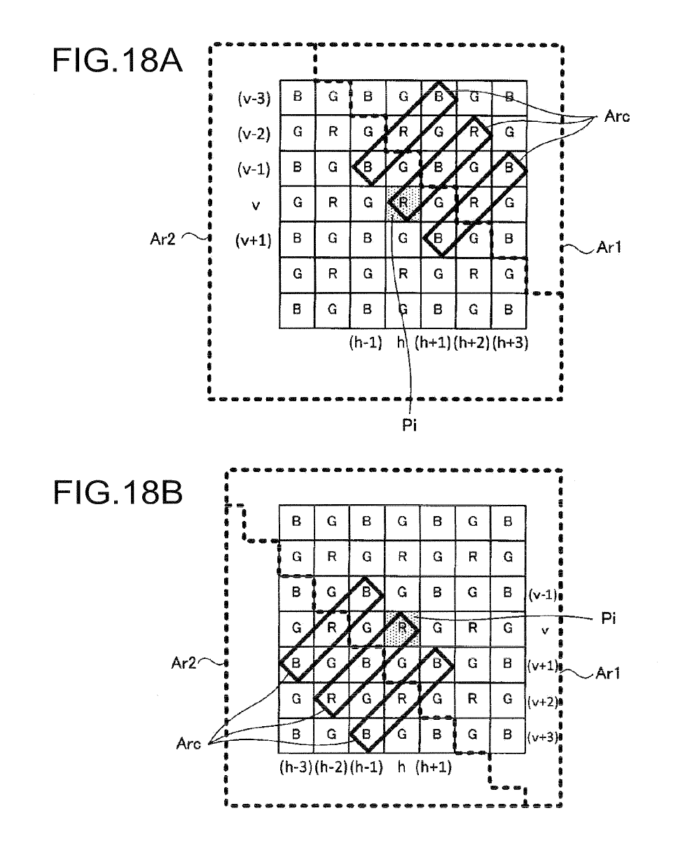

Note that the position of the 135°-direction boundary in the 45°-direction can be a position passing through an upper right corner of the target pixel Pi as shown by a dashed line in FIG. 18A or a position passing through a lower left corner of the target pixel Pi as shown by a dashed line in FIG. 18B. If the pixel change amount is calculated considering such a possibility, the boundary detection accuracy can be further increased. In this case, the difference absolute values are calculated in the pixel change amount calculation areas Arc shown in FIGS. 18A and 18B.

The pixel change amount calculation areas Arc shown in FIG. 18A include a line constituted of three pixels arranged in the 45°-direction from a position of B on an upper left-hand side of the target pixel Pi, a line constituted of three pixels arranged in the 45°-direction from a position of the target pixel Pi, and a line constituted of three pixels arranged in the 45°-direction from the position of B on a lower right-hand side of the target pixel Pi. The pixel change amount calculation areas Arc shown in FIG. 18B include a line constituted of three pixels arranged in the 45°-direction from a position of B on an upper left-hand side of the target pixel Pi, a line constituted of three pixels arranged in the 45°-direction from a position of the target pixel Pi, and a line constituted of three pixels arranged in the 45°-direction from the position of B on a lower right-hand side of the target pixel Pi. That is, the pixel change amount calculation areas Arc shown in FIG. 18A include the target pixel Pi in a lower left portion thereof in the 45°-direction. The pixel change amount calculation areas Arc shown in FIG. 18B include the target pixel Pi in an upper right portion thereof. Further, it is characterized in that the pixel change amount calculation areas Arc shown in both FIGS. 18A and 18B are the three lines for calculating the pixel change amount.

When the pixel change amount in the pixel change amount calculation areas Arc shown in FIG. 18A is expressed by dif_cross_{—}135_ne, the pixel change amount dif_cross_{—}135_ne can be calculated using Expression 18 below.

dif_cross_{—}135_{—}ne=(abs(B(h−1,v−1)−B(h+1,v−3))+abs(R(h,v)−R(h+2,v−2))+abs(B(h+1,v+1)−B(h+3,v−1)))/3 Expression 18

Further, when the pixel change amount in the pixel change amount calculation areas Arc shown in FIG. 18B is expressed by dif_cross_{—}135_sw, the pixel change amount dif_cross_{—}135_sw can be calculated using Expression 19 below.

dif_cross_{—}135_{—}sw=(abs(B(h−1,v−1)−B(h−3,v+1))+abs(R(h,v)−R(h−2,v+2))+abs(B(h+1,v+1)−B(h−1,v+3)))/3 Expression 19

That is, in Expressions 18 and 19, calculation in which an average value of the difference absolute values obtained in the three lines for calculating the pixel change amount is used as the pixel change amount in the pixel change amount calculation areas Arc is performed. Then, the pixel change amount dif_cross_{—}135_ne in the pixel change amount calculation area Arc shown in FIG. 18A and the pixel change amount dif_cross_{—}135_sw in the pixel change amount calculation area Arc shown in FIG. 18B, one having a larger value is set as the pixel change amount dif_cross_{—}135 in the direction perpendicular to the 135°-boundary direction. The pixel change amount dif_cross_{—}135 can be calculated using Expression 20 below.

dif_cross_{—}135=MAX(dif_cross_{—}135_{—}ne,dif_cross_{—}135_{—}sw) Expression 20

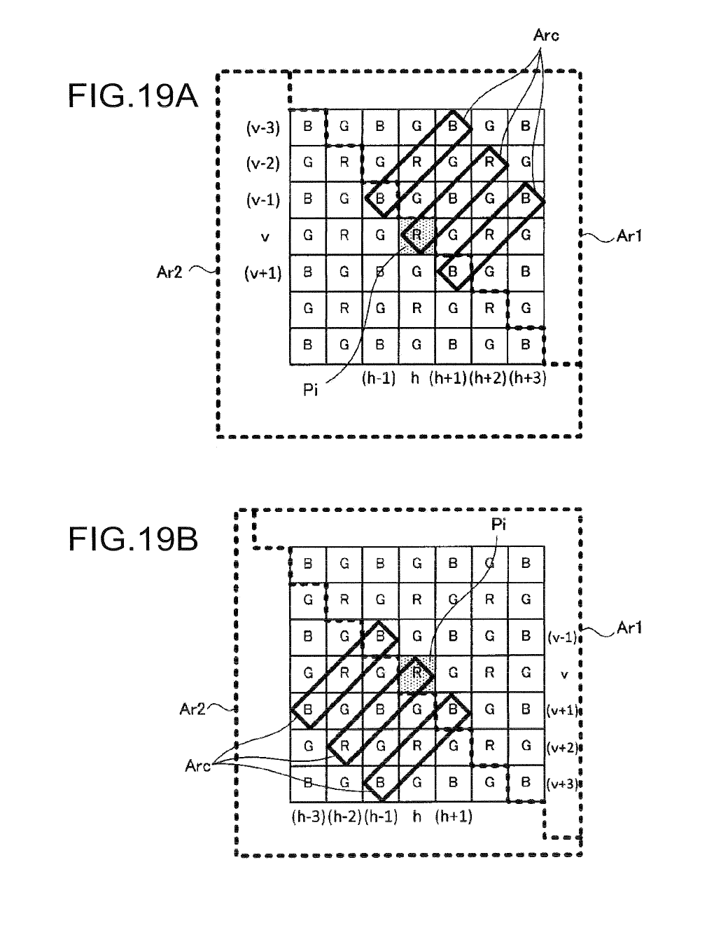

In this manner, the positions of the pixel change amount calculation areas Arc are set to the position including the target pixel Pi in the lower left portion thereof in the 45°-direction and the position including the target pixel Pi in the upper right portion thereof in the 45°-direction. Thus, it can cope with both cases where the boundary passes on the upper right-hand side and the lower left-hand side of the target pixel Pi. FIG. 19A shows an example of the case where the boundary passes on the upper right-hand side of the target pixel Pi. FIG. 19B shows an example of the case where the boundary passes on the lower left-hand side of the target pixel Pi. The positions of the pixel change amount calculation areas Arc shown in FIG. 19A are the same as those shown in FIG. 18A. The positions of the pixel change amount calculation areas Arc shown in FIG. 19B are the same as those shown in FIG. 18B. As can be seen in FIGS. 19A and 19B, the boundary denoted by the dashed line is included in the pixel change amount calculation areas Arc the same as those shown in FIGS. 18A and 18B.

That is, by setting the pixel change amount calculation areas Arc at the positions shown in FIG. 18A (FIG. 19A) and the positions shown in FIG. 18B (FIG. 19B), the pixel change amount calculation areas Arc include all the boundaries passing through the upper right corner and the lower left corner and passing on the upper right-hand side and on the lower left-hand side of the target pixel Pi.

### [3-2. Exemplary Processing of Boundary Direction Determination Unit and Interpolation Value Calculation Unit]

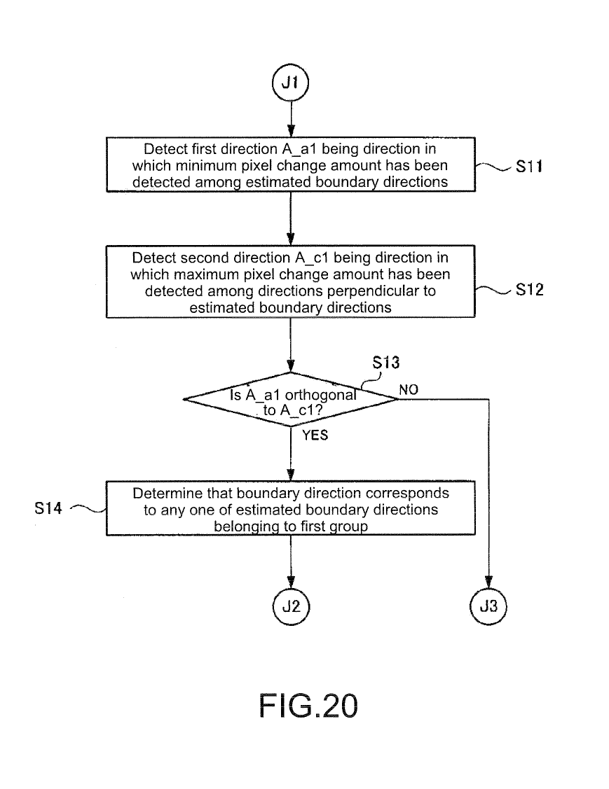

Next, exemplary processing of the boundary direction determination unit 502 of the color interpolation processor 50, that follows processing of the connector J1 in FIG. 5, will be described with reference to a flowchart of FIG. 20. First, a direction in which a minimum pixel change amount among the pixel change amounts in the estimated boundary directions calculated by the pixel change amount calculation unit 501 is calculated is detected (Step S11). When the minimum value of the pixel change amount is expressed by dif_along_n1, the minimum value of the pixel change amount dif_along_n1 can be calculated using Expression 21 below.

dif_along_{—}n1=MIN(dif_along_{—}0,dif_along_{—}90,dif_along_{—}45,dif_along_{—}135) Expression 21

Then, the estimated boundary direction in which the pixel change amount dif_along_n1 is calculated is referred to as a first direction A_a1.

Subsequently, a direction in which a maximum pixel change amount among the pixel change amounts in the directions perpendicular to the estimated boundary directions calculated by the pixel change amount calculation unit 501 is calculated is detected (Step S12). When the maximum value of the pixel change amount is expressed by dif_cross_m1, the maximum value of the pixel change amount dif_cross_m1 can be calculated using Expression 22 below.

dif_cross_{—}m1=MAX(dif_cross_{—}0,dif_cross_{—}90,dif_cross_{—}45,dif_cross_{—}135) Expression 22

Then, the estimated boundary direction in which the pixel change amount dif_cross_m1 is calculated, that is, a numeral part immediately after “dif_cross_” is referred to as a third direction A_r1. A direction perpendicular to A_r1, that is, a direction in which the pixel change amount is maximum is referred to as a second direction A_c1.

Next, the boundary direction determination unit 502 determines whether or not the first direction A_a1 is orthogonal to the second direction A_c1 (Step S13). If the first direction A_a1 is orthogonal to the second direction A_c1, the boundary direction determination unit 502 determines that the boundary direction is any one of the estimated boundary directions belonging to the first group (Step S14). The processing proceeds to a connector J2. If the first direction A_a1 is not orthogonal to the second direction A_c1, the processing proceeds to a connector J3.

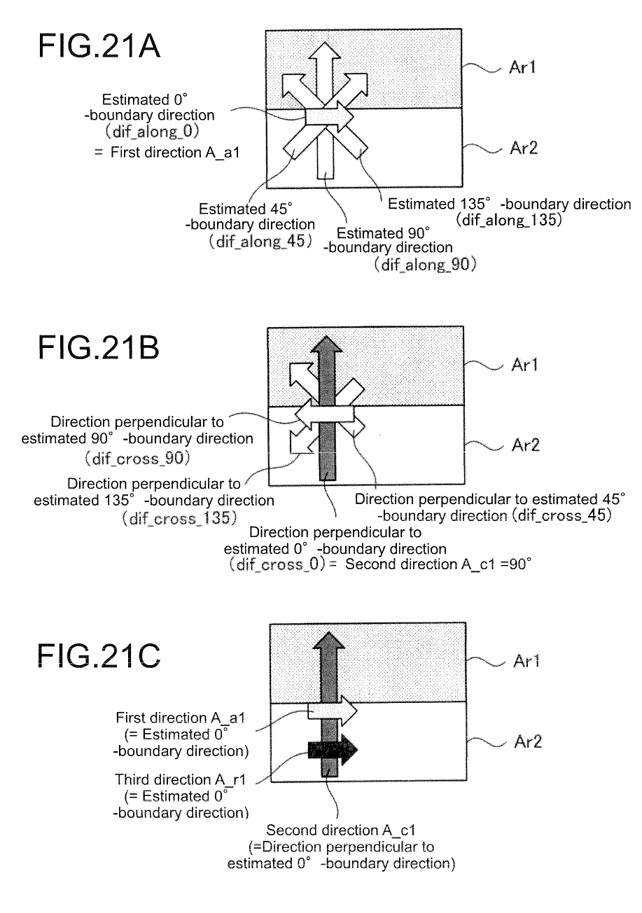

Now, referring to FIGS. 21A to 21C, a reason for why the boundary direction can be determined based on information on the first direction A_a1 and the second direction A_c1 will be described. FIGS. 21A to 21C show the estimated boundary directions by arrows. Here, the magnitude of the pixel change amount calculated in each of the directions is expressed by the length of the arrow. For example, a case where the actual boundary direction is 0° can be considered as a case where, as shown in FIG. 21A, the area Ar1 and the area Ar2 having pixels different in shading are adjacent to each other with the 0°-boundary direction being a boundary. In this case, out of the pixel change amounts calculated in the estimated boundary directions, the pixel change amount dif_along_{—}0 calculated in the 0°-boundary direction is minimum. That is, the first direction A_a1 is the estimated 0°-boundary direction in which the pixel change amount dif_along_{—}0 is calculated.

Further, one having a maximum value among the pixel change amounts calculated in the directions perpendicular to the estimated boundary directions is a pixel change amount dif_cross_{—}0 as shown in FIG. 21B. That is, the second direction A_c1 is the direction perpendicular to the estimated 0°-boundary direction in which the pixel change amount dif_cross_{—}0 is calculated. Thus, in the case where the actual boundary is present on a 0°-line, as shown in FIG. 21C, the first direction A_a1 and the second direction A_c1 are orthogonal to each other.

Similarly, also in the case where the boundary is present on a 90°-line, in the case where the boundary is present on a 45°-line, or in the case where the boundary is present on a 135°-line, the first direction A_a1 and the second direction A_c1 are orthogonal to each other. Thus, when the first direction A_a1 and the second direction A_c1 are orthogonal to each other, it can be determined that the boundary direction corresponds to any one of the estimated boundary directions belonging to the first group.

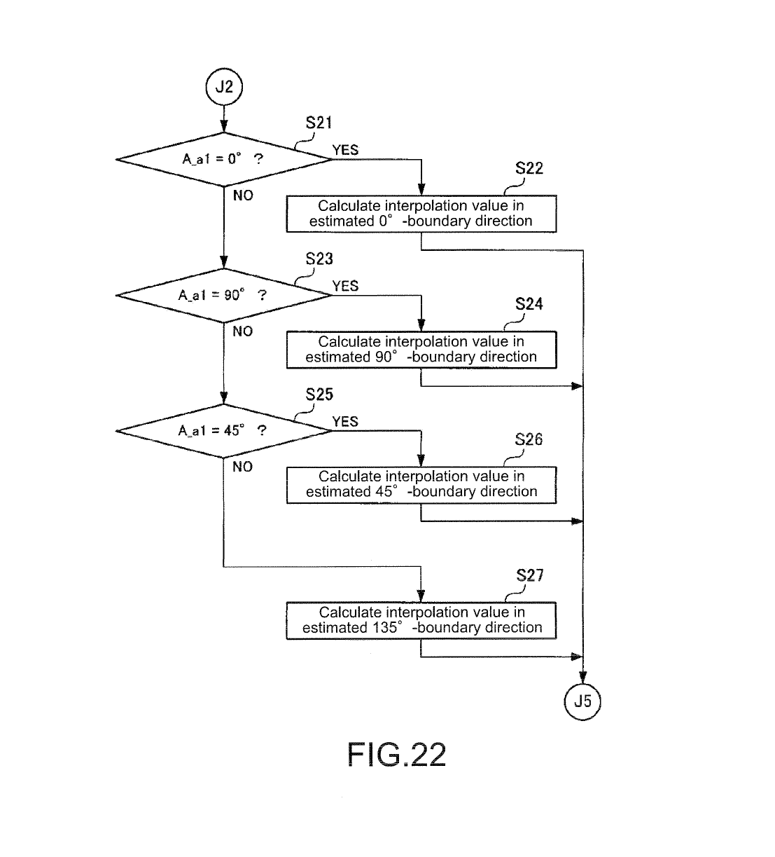

Next, referring to a flowchart of FIG. 22, processing following the connector J2 in FIG. 20 will be described. After the connector J2, the boundary direction determination unit 502 determines specifically which direction each of the estimated boundary directions determined to belong to the first group is (cf. FIG. 2). Based on a result of the determination, the interpolation value calculation unit 503 selects the interpolation value calculation method corresponding to each estimated boundary direction.

First, the boundary direction determination unit 502 determines whether or not the first direction A_a1 is 0° (Step S21). If the first direction A_a1 is 0°, the interpolation value calculation unit 503 calculates an interpolation value by an interpolation value calculation method for the estimated 0°-boundary direction (Step S22). The processing proceeds to a connector J5. If the first direction A_a1 is not 0°, then the boundary direction determination unit 502 determines whether or not the first direction A_a1 is 90° (Step S23). If the first direction A_a1 is 90°, the interpolation value calculation unit 503 calculates an interpolation value by an interpolation value calculation method for the estimated 90°-boundary direction (Step S24). The processing proceeds to the connector J5.

If the first direction A_a1 is not 90°, the boundary direction determination unit 502 determines whether or not the first direction A_a1 is 45° (Step S25). If the first direction A_a1 is 45°, the interpolation value calculation unit 503 calculates an interpolation value by an interpolation value calculation method for the estimated 45°-boundary direction (Step S26). The processing proceeds to the connector J5. If the first direction A_a1 is not 45°, the interpolation value calculation unit 503 calculates an interpolation value by an interpolation value calculation method for the estimated 135°-boundary direction (Step S27). The processing proceeds to the connector J5.

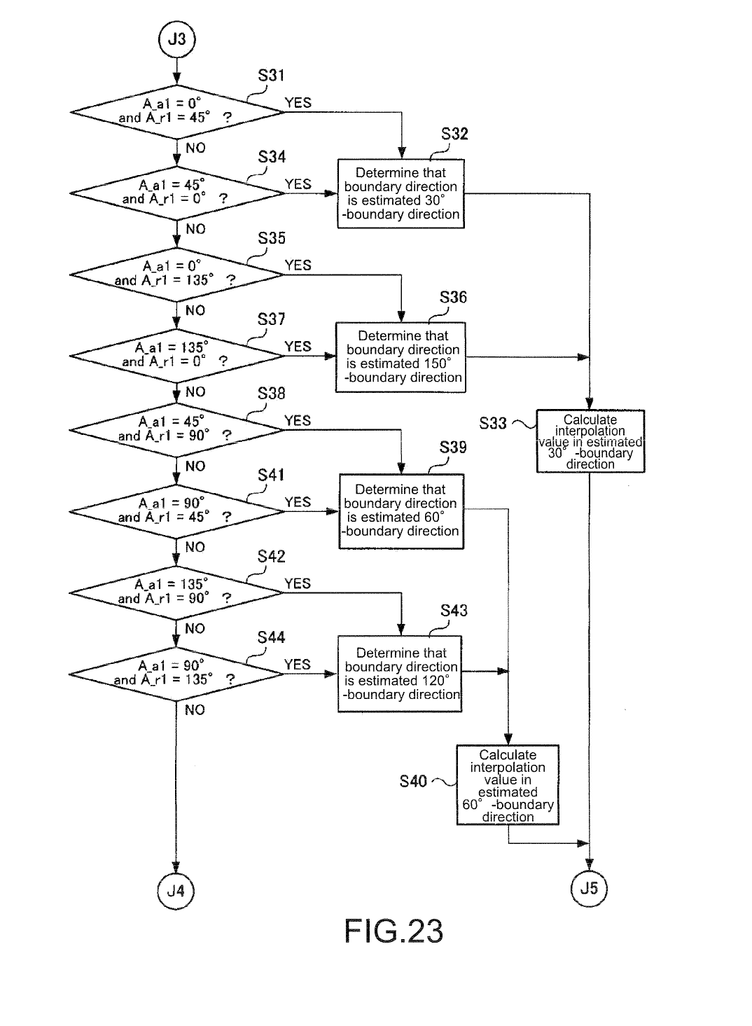

Next, exemplary processing following the connector J3 in FIG. 20 will be described with reference to a flowchart of FIG. 23. After the connector J3, the boundary direction determination unit 502 determines which of the estimated boundary directions belonging to the second group the boundary direction corresponds to, or whether or not the boundary direction corresponds to any one of the estimated boundary directions belonging to the second group. Specifically, when the first direction A_a1 and the third direction A_r1 are directions adjacent to each other among the estimated boundary directions belonging to the first group, the boundary direction determination unit 502 determines that the boundary direction is the estimated boundary direction of the second group that is located at a position sandwiched between those two directions. Then, based on a result of the determination, the interpolation value calculation unit 503 selects the interpolation value calculation method corresponding to each estimated boundary direction.

First, the boundary direction determination unit 502 determines whether or not the first direction A_a1 is 0° and the third direction A_r1 is 45° (Step S31). If “Yes,” the boundary direction determination unit 502 determines that the boundary direction is in the estimated 30°-boundary direction (Step S32). The interpolation value calculation unit 503 calculates an interpolation value by an interpolation value calculation method for the estimated 30°-boundary direction (Step S33). If “No” is selected in Step S31, the boundary direction determination unit 502 determines whether or not the first direction A_a1 is 45° and the third direction A_r1 is 0° (Step S34). If “Yes,” the boundary direction determination unit 502 determines that the boundary direction is in the estimated 30°-boundary direction (Step S32). The interpolation value calculation unit 503 calculates the interpolation value by the interpolation value calculation method for the estimated 30°-boundary direction (Step S33). The processing proceeds to the connector J5.

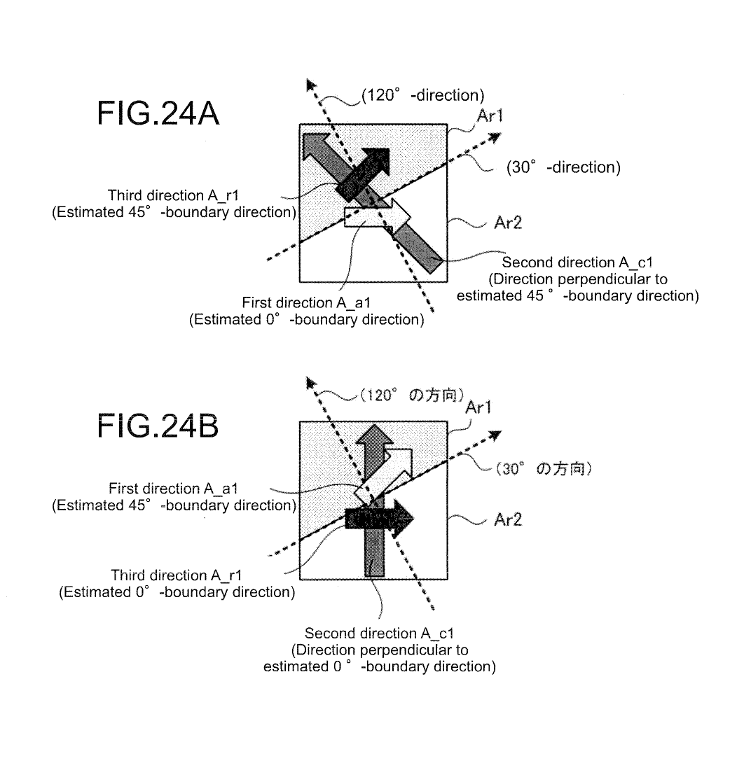

FIGS. 24A and 24B are diagrams each showing exemplary configurations of the area Ar1 and the area Ar2 when the boundary direction is 30°. When the boundary direction is 30°, the area Ar1 and the area Ar2 largely different from each other in pixel value can be considered to be adjacent to each other with the boundary present in a 30°-direction being a boundary. In this case, the pixel change amount is minimum in the 30°-direction being the boundary direction. The pixel change amount is maximum in a 120°-direction being the direction perpendicular to the boundary direction.

However, if pixel change amounts are calculated also in such estimated boundary directions classified into the second group, the amount and time of calculation increases. Therefore, in the embodiment of the present disclosure, estimated boundary directions in the second group are also determined using a result of the calculation of the first group in which the pixel change amounts have been calculated.

For example, as shown in FIG. 24A, it is assumed that the estimated boundary direction in which the calculated pixel change amount is minimum, that is, the first direction A_a1 is 0° (first estimated boundary direction: first group). Further, it is assumed that the direction perpendicular to the estimated boundary direction in which the calculated pixel change amount is maximum, that is, the second direction A_c1 is 135° (third estimated boundary direction: first group). Then, the third direction A_r1 is 45° (third estimated boundary direction: first group). In this manner, when the first direction A_a1 and the third direction A_r1 are directions adjacent to each other among the estimated boundary directions belonging to the first group, the boundary direction determination unit 502 determines that the boundary direction is the estimated boundary direction in the second group that is located at a position sandwiched by those two directions.

For example, when the first direction A_a1 is 0° and the third direction A_r1 is 45° as shown in FIG. 24A, the boundary direction determination unit 502 can determine that the boundary direction is in the estimated 30°-boundary direction. Further, also when the first direction A_a1 is 45° and the third direction A_r1 is 0° as shown in FIG. 24B, the boundary direction determination unit 502 can determine that the boundary direction is in the estimated 30°-boundary direction.

Referring back to FIG. 23, the description will be continued. If “No” is selected in Step S34, the boundary direction determination unit 502 determines whether or not the first direction A_a1 is 0° and the third direction A_r1 is 135° (Step S35). If “Yes,” the boundary direction determination unit 502 determines that the boundary direction is in the estimated 150°-boundary direction (Step S36). The interpolation value calculation unit 503 calculates the interpolation value by the interpolation value calculation method for the estimated 30°-boundary direction (Step S33). The processing proceeds to the connector J5. A reason why the interpolation value calculation method common to that for the estimated 30°-boundary direction can be used also when the boundary direction determination unit 502 determines that the boundary direction is in the estimated 150°-boundary direction will be described while describing the processing by the interpolation value calculation unit 503 to be described later.

If “No” is selected in Step S35, the boundary direction determination unit 502 determines whether or not the first direction A_a1 is 135° and the third direction A_r1 is 0° (Step S37). If “Yes,” the boundary direction determination unit 502 determines that the boundary direction is in the estimated 150°-boundary direction (Step S36). The interpolation value calculation unit 503 calculates the interpolation value by the interpolation value calculation method for the estimated 30°-boundary direction (Step S33).

If “No” is selected in Step S37, the boundary direction determination unit 502 determines whether or not the first direction A_a1 is 45° and the third direction A_r1 is 90° (Step S38). If “Yes,” the boundary direction determination unit 502 determines that the boundary direction is in the estimated 60°-boundary direction (Step S39). The interpolation value calculation unit 503 calculates an interpolation value by an interpolation value calculation method for the estimated 60°-boundary direction (Step S40). The processing proceeds to the connector J5. If “No” is selected in Step S38, the boundary direction determination unit 502 determines whether or not the first direction A_a1 is 90° and the third direction A_r1 is 45° (Step S41). If “Yes,” the boundary direction determination unit 502 determines that the boundary direction is in the estimated 60°-boundary direction (Step S39). The interpolation value calculation unit 503 calculates the interpolation value by the interpolation value calculation method for the estimated 60°-boundary direction (Step S40). The processing proceeds to the connector J5.

If “No” is selected in Step S41, the boundary direction determination unit 502 determines whether or not the first direction A_a1 is 135° and the third direction A_r1 is 90° (Step S42). If “Yes,” the boundary direction determination unit 502 determines that the boundary direction is in the estimated 120°-boundary direction (Step S43). The interpolation value calculation unit 503 calculates the interpolation value by the interpolation value calculation method for the estimated 60°-boundary direction (Step S40). Also a reason why the interpolation value calculation method common to that for the estimated 60°-boundary direction can be used also when the boundary direction determination unit 502 determines that the boundary direction is in the estimated 120°-boundary direction will be described while describing the processing by the interpolation value calculation unit 503 to be described later.

If “No” is selected in Step S42, the boundary direction determination unit 502 determines whether or not the first direction A_a1 is 90° and the third direction A_r1 is 135° (Step S44). If “Yes,” the boundary direction determination unit 502 determines that the boundary direction is in the estimated 120°-boundary direction (Step S43). The interpolation value calculation unit 503 calculates the interpolation value by the interpolation value calculation method for the estimated 60°-boundary direction (Step S40). If “No” is selected in Step S44, the processing proceeds to a connector J4.

### [3-3. Examples of Interpolation Value Calculation Method in Each Estimated Boundary Direction by Interpolation Value Calculation Unit]

Next, specific interpolation value calculation methods by the interpolation value calculation unit will be described in the following order.

3-3-1. Interpolation Value Calculation Method in Estimated 0°-Boundary Direction

3-3-2. Interpolation Value Calculation Method in Estimated 90°-Boundary Direction

3-3-3. Interpolation Value Calculation Method in Estimated 45°-Boundary Direction

3-3-4. Interpolation Value Calculation Method in Estimated 135°-Boundary Direction

3-3-5. Interpolation Value Calculation Method in Estimated 30°-Boundary Direction

3-3-6. Interpolation Value Calculation Method in Estimated 60°-Boundary Direction

3-3-7. Interpolation Value Calculation Method if Boundary Does Not Correspond to Any One of Estimated Boundary Directions

### (3-3-1. Interpolation Value Calculation Method in Estimated 0°-Boundary Direction)

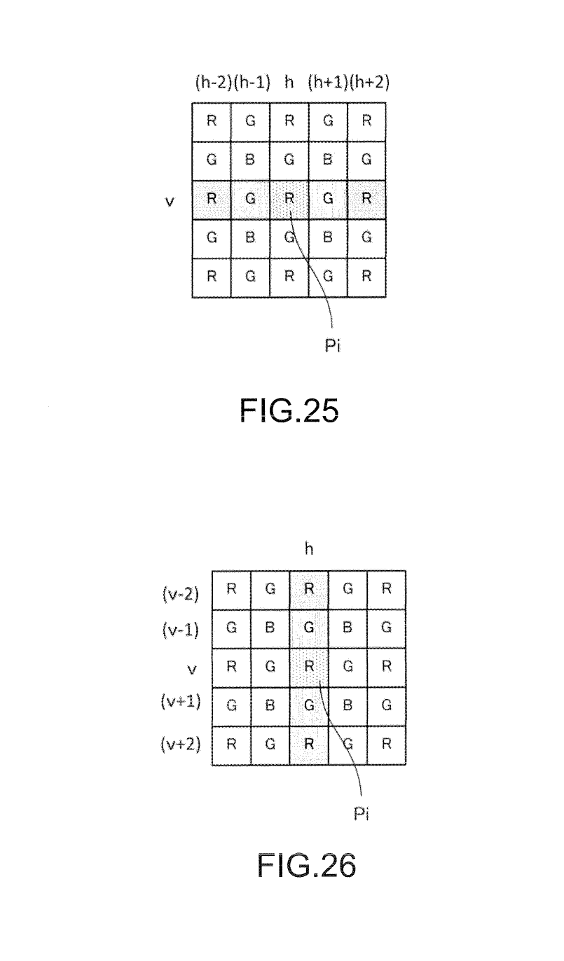

First, an interpolation value calculation method in the estimated 0°-boundary direction will be described with reference to FIG. 25. In the following description, an interpolation value of the target pixel Pi is expressed by g (h, v). Regarding the estimated 0°-boundary direction, as shown in FIG. 25, the interpolation value is calculated using pixel values G (h−1, v) and G (h+1, v) of G-pixels adjacent, on the left- and right-hand sides, to the target pixel Pi.

Note that, regarding the estimated 0°-boundary direction, an average value of two pixel values G (h−1, v) and G (h+1, v) adjacent to the target pixel Pi is set as the interpolation value. The calculation formula for the interpolation value g (h, v) in this case is Expression 23 below.

g(h,v)=(G(h−1,v)+G(h+1,v))/2 Expression 23

Note that, when the pixel value R (h, v) of the target pixel Pi is an extreme value as compared to the pixel values (R (h−2, v) and R (h+2, v)) of pixels that are closest to the target pixel Pi and have the same color component as that of the target pixel Pi that, correction may be performed considering the luminance of the target pixel as being an extreme value. That is, information on a difference between the pixel value of the target pixel Pi and each of the pixel values R (h, v), R (h−2, v), and R (h+2, v) of pixels that are closest to the target pixel Pi and have the same color component as that of the target pixel Pi may be reflected to the interpolation value. The interpolation value g (h, v) in this case can be calculated using Expression 24 below.

g(h,v)=(G(h−1,v)+G(h+1,v))/2+((R(h,v)−R(h−2,v))+(R(h,v)−R(h+2,v)))/2×scly Expression 24

Here, scly denotes a coefficient for adjusting an effect of a correction item and is set to, for example, a value satisfying the following expression.

1≧scly.

### (3-3-2. Interpolation Value Calculation Method in Estimated 90°-Boundary Direction)

Next, an interpolation value calculation method in the estimated 90°-boundary direction will be described with reference to FIG. 26. Regarding the estimated 90°-boundary direction, as shown in FIG. 26, the interpolation value is calculated using the pixel values G (h, v−1) and G (h, v+1) of upper and lower G-pixels adjacent to the target pixel Pi. The calculation formula for the interpolation value g (h, v) in this case is Expression 25 below.

g(h,v)=(G(h,v−1)+G(h,v+1))/2 Expression 25

Note that, also regarding the estimated 90°-boundary direction, when the pixel value R (h, v) of the target pixel Pi is an extreme value as compared to the pixel values (R (h, v−2) and R (h, v+2)) of pixels that are closest to the target pixel Pi and have the same color component as that of the target pixel Pi, correction may be performed considering the luminance of the target pixel as being an extreme value. The interpolation value g (h, v) in this case can be calculated using Expression 26 below.

g(h,v)=(G(h,v−1)+G(h,v+1))/2+((R(h,v)−R(h,v−2))+(R(h,v)−R(h,v+2)))/2×scly Expression 26

Also here, scly denotes a coefficient for adjusting an effect of a correction item and is set to, for example, a value satisfying the following expression.

1≧scly.

### (3-3-3. Interpolation Value Calculation Method in Estimated 45°-Boundary Direction)

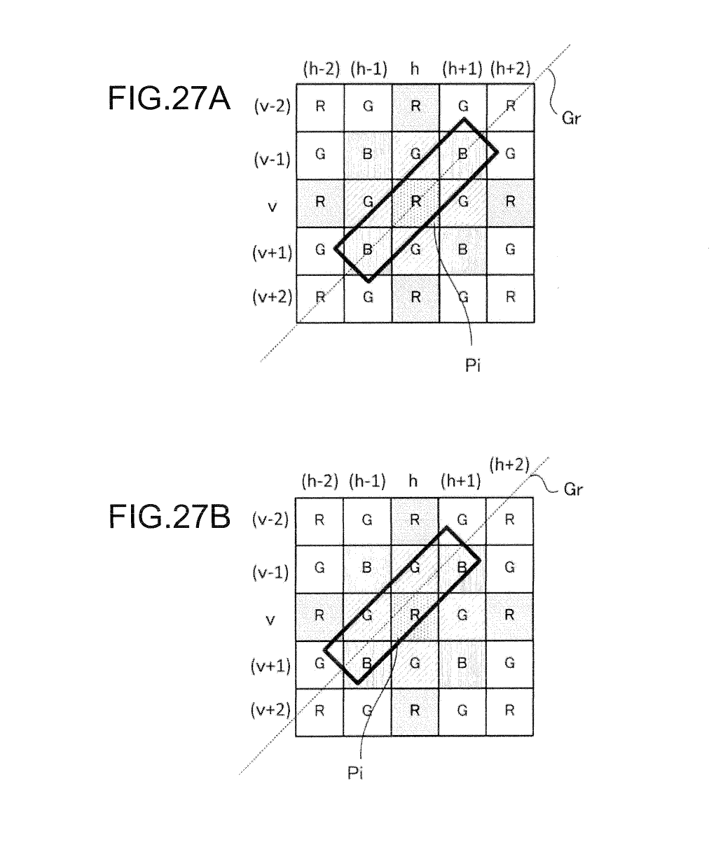

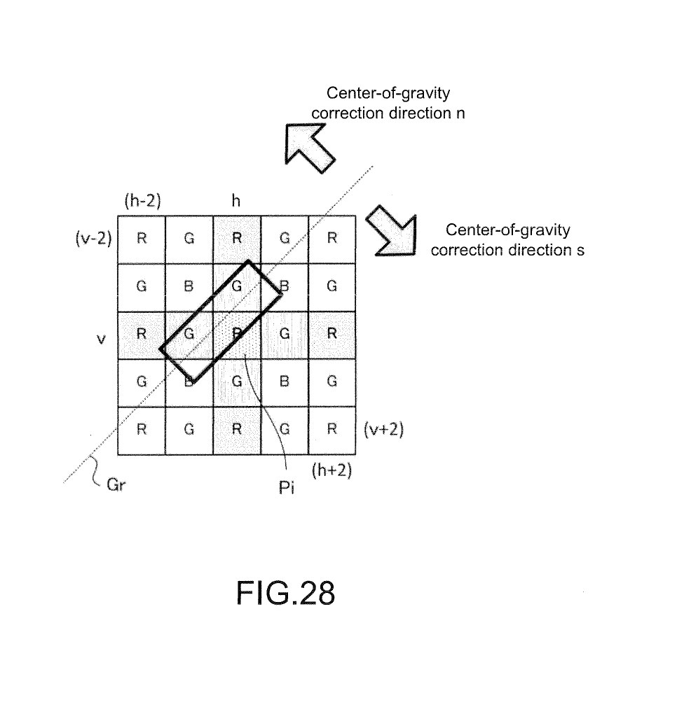

Next, interpolation value calculation method in the estimated 45°-boundary direction will be described with reference to FIGS. 27A to 28. In the estimated 45°-boundary direction, pixel values G (h, v−1), G (h−1, v), G (h+1, v), and G (h, v+1) of four G-pixels adjacent to the target pixel Pi are used for calculating the interpolation value. Regarding the estimated 45°-boundary direction, a calculation method for the interpolation value is changed depending on whether or not the boundary passes through a center of the target pixel Pi.

FIGS. 27A and 27B are diagrams each showing an image of a positional correspondence between a center line (hereinafter, referred to as “center of gravity of the boundary”) in a longitudinal direction of a boundary area in the case where the boundary direction is 45° and the target pixel Pi. FIG. 27A shows an example of a case where the center of gravity of the boundary passes through almost the center of the target pixel Pi. FIG. 27B shows an example of a case where the center of gravity of the boundary passes through a position deviated from the center of the target pixel Pi.

As shown in FIG. 27A, in the case where a center of gravity Gr of the boundary passes through almost the center of the target pixel Pi, the pixel value R (h, v) of the target pixel Pi is larger or smaller as compared to the pixel values (R (h, v−2), R (h−2, v), R (h+2, v), and R (h, v+2)) that are closest to the target pixel Pi and have the same color component as that of the target pixel Pi. Then, portions in which four G-pixels adjacent to the target pixel Pi and a boundary overlap with each other have the same area for each of the four G-pixels. The four G-pixels are shown by oblique lines and the boundary is shown by a thick frame. Thus, in the case where the pixel value R (h, v) of the target pixel Pi is the maximum value or the minimum value (extreme value) as compared to the pixel values that are closest to the target pixel Pi and have the same color component as that of the target pixel Pi, the center of gravity Gr of the boundary is considered as passing through almost the center of the target pixel Pi. A value obtained by simply averaging the four G-pixels is set as the interpolation value. The calculation formula for the interpolation value g (h, v) in this case can be calculated using Expression 27 below.

g(h,v)=(G(h,v−1)+G(h−1,v)+G(h+1,v)+G(h,v+1))/4 Expression 27

Note that, if the boundary direction determination unit 502 determines that the center of gravity Gr of the boundary passes through almost the center of the target pixel Pi, correction of luminance in which information on pixel values of pixels that are closest to the target pixel Pi and have the same color component as that of the target pixel Pi is reflected to the interpolation value g (h, v) may be performed. In this case, using the pixel values R (h, v−2), R (h−2, v), R (h+2, v), and R (h, v+2) of the pixels that are closest to the target pixel Pi and have the same color component as that of the target pixel Pi, a correction item is created. Then, the correction item is added to a value obtained by simply averaging the four G-pixels. A calculation formula for the interpolation value g (h, v) when the correction of luminance is performed is expressed by Expression 28 below.

g(h,v)=(G(h,v−1)+G(h−1,v)+G(h+1,v)+G(h,v+1))/4+((R(h,v)−R(h,v−1))+(R(h,v)−R(h−1,v))+(R(h,v)−R(h,v+1))+(R(h,v)−R(h,v−1)))/4×scly Expression 28

Also here, scly denotes a coefficient for adjusting an effect of a correction item and is set to, for example, a value satisfying the following expression.

1≧scly.

Meanwhile, as shown in FIG. 27B, in the case where the center of gravity Gr of the boundary passes through a position deviated from almost the center of the target pixel Pi, portions in which four G-pixels adjacent to the target pixel Pi and a boundary overlap with each other do not have the same area in the four G-pixels. The four G-pixels are shown by oblique lines and the boundary is shown by a thick frame. In such a case, the pixel value R (h, v) of the target pixel Pi is not the extreme value as compared to the pixel values (R (h, v−2), R (h−2, v), R (h+2, v), and R (h, v+2)) that are closest to the target pixel Pi and have the same color component as that of the target pixel Pi.

Therefore, in the case where the pixel value of the target pixel Pi is not the extreme value as compared to the pixel values of the pixels that are closest to the target pixel Pi and have the same color component as that of the target pixel Pi, the boundary direction determination unit 502 can determine that the center of gravity of the boundary is deviated from the center of the target pixel Pi. Thus, it is necessary to calculate an interpolation value by not simple averaging of the four G-pixels but weighted averaging using a weight coefficient corresponding to the amount of deviation of the center-of-gravity. A calculation formula in this case is Expression 29 below.

g(h,v)=scale_{—}n×(G(h,v−1)+G(h−1,v))+scale_{—}s×(G(h+1,v)+G(h,v+1)) Expression 29

“scale_n” and “scale_s” in Expression 29 above denotes weight coefficients. Specifically, “scale_n” denotes a coefficient for defining a weight in an upper left-hand direction shown as “Center-of-gravity correction direction n” in FIG. 28. “scale_s” denotes a coefficient for defining a weight in a lower right-hand direction shown as “Center-of-gravity correction direction s.”

Values of G (h, v−1), G (h−1, v), G (h+1, v), and G (h, v+1) have to be added as positive values to the interpolation value g (h, v). Therefore, “scale_n” and “scale_s” are set to be values satisfying the following expressions.

scale_{—}n×2+scale_{—}s×2=1

scale_{—}n>0

scale_{—}s>0

In the case where it is unnecessary to consider the deviation of the center of gravity of the boundary, “scale_n” and “scale_s” are the same values which are 0.25.

When the amount of correction for defining the ratio of “scale_n” to “scale_s” is referred to as a correction amount tmp, “scale_n” and “scale_s” are expressed as follows.

scale_{—}n=0.25−tmp

scale_{—}s=0.25+tmp

The value of the correction amount tmp can be calculated using Expression 30 below.

Correction amount tmp=(dif_{—}n−dif_{—}s)/(dif_{—}n+dif_{—}s)×adj0 Expression 30

G (h, v−1), G (h−1, v), G (h+1, v), and G (h, v+1) used for calculating the interpolation value g (h, v) have to be added as positive values to the interpolation value g (h, v). That is, an absolute value of the correction amount tmp needs to be adjusted to be below 0.25. “adj0” of Expression 30 above denotes a coefficient for adjustment. For example, the value of 0.125 is set as “adj0.”

In Expression 30 above, “dif_n” denotes a difference absolute value between the pixel value R (h, v) of the target pixel Pi and each of the pixel values of the pixels that are closest to the target pixel Pi on the upper side and the left-hand side and have the same color. “dif_s” denotes a difference absolute value between the pixel value R (h, v) of the target pixel Pi and each of the pixel values of the pixels that are closest to the target pixel Pi on the lower side and the right-hand side and have the same color. “dif_n” can be calculated using Expression 31 below. “dif_s” can be calculated using Expression 32 below.

dif_{—}n=(abs(R(h,v)−R(h,v−2))+abs(R(h,v)−R(h−2,v))) Expression 31

dif_{—}s=(abs(R(h,v)−R(h,v+2))+abs(R(h,v)−R(h+2,v))) Expression 32

### (3-3-4. Interpolation Value Calculation Method in Estimated 135°-Boundary Direction)

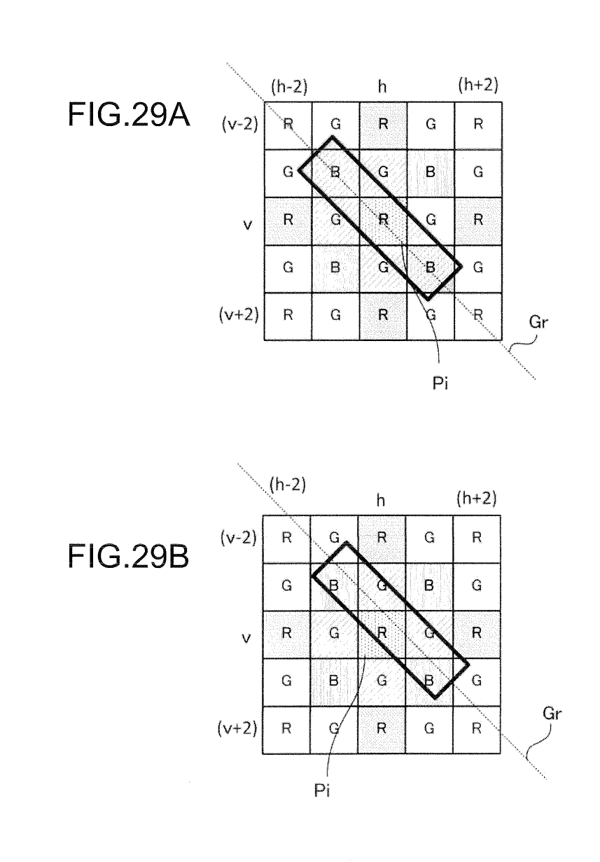

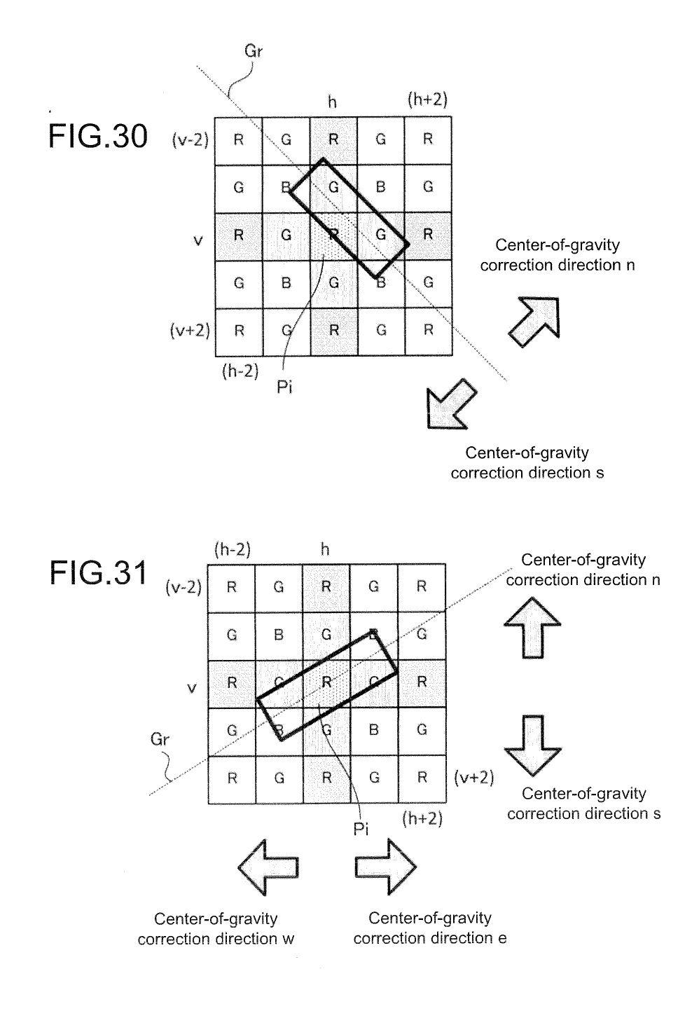

Next, the interpolation value calculation method in the estimated 135°-boundary direction will be described with reference to FIGS. 30 to 29B. Also regarding the estimated 135°-boundary direction, the pixel values G (h, v−1), G (h−1, v), G (h+1, v), and G (h, v+1) of the four G-pixels adjacent to the target pixel Pi are used for calculating the interpolation value. Further, also regarding the estimated 135°-boundary direction, the calculation method for the interpolation value is changed depending on whether or not the boundary passes through the center of the target pixel Pi.

FIGS. 29A and 29B are diagrams each showing an image of a positional correspondence between the center of gravity of the boundary and the target pixel Pi in the case where the boundary direction is 135°. FIG. 29A shows an example of a case where the center of gravity of the boundary passes through almost the center of the target pixel Pi. FIG. 29B shows an example of a case where the center of gravity of the boundary passes through a position deviated from the center of the target pixel Pi.

As shown in FIG. 29A, in the case where the center of gravity Gr of the boundary passes through almost the center of the target pixel Pi, portions in which four G-pixels adjacent to the target pixel Pi and a boundary overlap with each other have the same area for each of the four G-pixels. The four G-pixels are shown by oblique lines and the boundary is shown by a thick frame. Therefore, a value obtained by simply averaging the four G-pixels can be set as the interpolation value. The interpolation value g (h, v) in this case can be calculated using Expression 27 above.

Note that, if the boundary direction determination unit 502 determines that the center of gravity Gr of the boundary passes through almost the center of the target pixel Pi, correction of luminance in which information on pixel values of pixels that are closest to the target pixel Pi and have the same color component as that of the target pixel Pi is reflected to the interpolation value g (h, v) may be performed as in the case of the 45°-boundary direction. The calculation formula in this case is expressed by Expression 28 above.

Meanwhile, as shown in FIG. 29B, in the case where the center of gravity Gr of the boundary passes through a position deviated from almost the center of the target pixel Pi, portions in which four G-pixels adjacent to the target pixel Pi and a boundary overlap with each other do not have the same area in the four G-pixels. The four G-pixels are shown by oblique lines and the boundary is shown by a thick frame. In such a case, the pixel value R (h, v) of the target pixel Pi is not the extreme value as compared to the pixel values (R (h, v−2), R (h−2, v), R (h+2, v), and R (h, v+2)) that are closest to the target pixel Pi and have the same color component as that of the target pixel Pi.

Therefore, in the case where the pixel value of the target pixel Pi is the extreme value as compared to the pixel values of the pixels that are closest to the target pixel Pi and have the same color component as that of the target pixel Pi, the boundary direction determination unit 502 can determine that the center of gravity of the boundary is deviated from the center of the target pixel Pi. Thus, it is necessary to calculate the interpolation value by not simple averaging of the four G-pixels but weighted averaging using a weight coefficient corresponding to the amount of deviation of the center of gravity. The interpolation value g (h, v) in this case can be calculated using Expression 33 below.

g(h,v)=scale_{—}n×(G(h,v−1)+G(h+1,v))+scale_{—}s×(G(h−1,v)+G(h,v+1)) Expression 33

Also here, the correction amount tmp is used for defining the allocation of “scale_n” and “scale_s” and the correction amount tmp can be calculated using Expression 30 above. Here, “scale_n” denotes a coefficient for defining a weight in the upper right-hand direction shown as “Center-of-gravity correction direction n” in FIG. 30. “scale_s” denotes a coefficient for defining a weight in the lower left-hand direction shown as “Center-of-gravity correction direction s.” The difference absolute value dif_n and the difference absolute value dif_s used for calculating the correction amount tmp can be calculated using Expressions 34 and 35 below.

dif_{—}n=(abs(R(h,v)−R(h,v−2))+abs(R(h,v)−R(h+2,v))) Expression 34

dif_{—}s=(abs(R(h,v)−R(h,v+2))+abs(R(h,v)−R(h−2,v))) Expression 35

### (3-3-5. Interpolation Value Calculation Method in Estimated 30°-Boundary Direction)

Next, an interpolation value calculation method in the estimated 30°-boundary direction will be described with reference to FIG. 31. Regarding the estimated 30°-boundary direction, as shown in FIG. 31, the pixel values G (h, v−1), G (h−1, v), (h+1, v), and G (h, v+1) of upper, lower, left, and right G-pixels adjacent to the target pixel Pi are used for calculating the interpolation value. The interpolation value g (h, v) can be calculated using Expression 36 below.

g(h,v)=scale_{—}n×G(h,v−1)+scale_{—}s×G(h,v+1)+scale_{—}w×G(h−1,v)+scale_{—}e×G(h+1,v) Expression 36

“scale_n”, “scale_s”, “scale_w”, and “scale_e” are weight coefficients. “scale_n” denotes a coefficient for defining a weight in an upper direction that is shown as “Center-of-gravity correction direction n” in FIG. 31. “scale_s” denotes a coefficient for defining a weight in a lower direction that is shown as “Center-of-gravity correction direction s.” “scale_w” denotes a coefficient for defining a weight in a left-hand direction shown as “Center-of-gravity correction direction w” in FIG. 31. “scale_e” denotes a coefficient for defining a weight in a right-hand direction shown as “Center-of-gravity correction direction e.” Each weight coefficient has to be added as a positive value to the interpolation value g (h, v). Therefore, the following relationships are established between the weight coefficients.

scale_{—}n+scale_{—}s+scale_{—}w+scale_{—}e=1

scale_{—}n>0

scale_{—}s>0

scale_{—}w>0

scale_{—}e>0

FIG. 31 is a diagram showing an example of a case where the boundary present in the 30°-direction passes through the center of the target pixel Pi. In the case where the boundary direction is 30°, portions in which the G-pixel (h+1, v) on the right-hand side and the G-pixel (h−1, v) on the left-hand side of the target pixel Pi and a boundary shown by a thick frame overlap with each other have a larger area than that of portions in which the G-pixel (h, v−1) on the upper side and the G-pixel (h, v+1) on the lower side and a boundary shown by a thick frame overlap with each other. Thus, in the estimated 30°-boundary direction, it is necessary to set the allocation of the weight coefficient “scale_w” for defining a weight on the left-hand side and the weight coefficient “scale_e” for defining a weight on the right-hand side to be larger than the allocation of “scale_n” for defining a weight on the upper side and “scale_s” for defining a weight on the lower side.

Here, a coefficient for defining the allocation of the weight coefficients “scale_n” and “scale_s” is referred to as “scl0” and a coefficient for defining the allocation of “scale_w” and “scale_e” is referred to as “scl1.” By setting “scl0” and “scl1” to be arbitrary values within a range satisfying the following expression, the allocation of “scale_w” and “scale_e” can be made larger than the allocation of “scale_n” and “scale_s.”

scl0+scl1=0.5

scl0<scl1

scl0>0

scl1>0

In the case where the center of gravity of the boundary is not deviated as shown in FIG. 31, scale_n=scale_s=scl0 and scale_w=scale_e=scl1. In the case where the center of gravity of the boundary is deviated, the interpolation value corresponding to the amount of deviation can be calculated using coefficients “dif_n”, “dif_s”, “dif_w”, and “dif_e” corresponding to the amount of deviation. The following are calculation formulae for the weight coefficients in the case where the center of gravity of the boundary is deviated.

scale_{—}n=scl0+dif_{—}n×adj1 Expression 37

scale_{—}s=scl0+dif_{—}s×adj1 Expression 38

scale_{—}w=scl1+dif_{—}w×adj2 Expression 39

scale_{—}e=scl1+dif_{—}e×adj2 Expression 40

“adj1” and “adj2” in Expressions 37 to 40 above denote coefficients for adjustment. A value is set as “adj1” such that, when an absolute value of “dif_n” and an absolute value of “dif_s” are multiplied by “adj1,” “adj1×dif_n” and “adj1×dif_s” are kept smaller than “scl0.” A value is set as “adj2” such that, when an absolute value of “dif_w” and an absolute value of “dif_e” are multiplied by “adj2,” “adj2×dif_w” and “adj2×dif_e” are kept smaller than “scl1.” “dif_n”, “dif_s”, “dif_w”, and “dif_e” can be calculated using Expressions 41 to 44 below.

dif_{—}e=(abs(R(h,v)−R(h−2,v))−abs(R(h,v)−R(h+2,v)))/(abs(R(h,v)−R(h−2,v))+abs(R(h,v)−R(h+2,v))) Expression 41

dif_{—}w=−dif_{—}e Expression 42

dif_{—}n=(abs(R(h,v)−R(h,v+2))−abs(R(h,v)−R(h,v−2)))/(abs(R(h,v)−R(h,v+2))+abs(R(h,v)−R(h,v−2)) Expression 43

dif_{—}s=−dif_{—}n Expression 44

Note that, in the case where the center of gravity of the boundary is not deviated as shown in FIG. 31, correction of luminance in which information on the pixel values of the pixels that are closest to the target pixel Pi and have the same color component as that of the target pixel Pi is reflected to the interpolation value g (h, v) may be performed. The calculation formula in this case is expressed by Expression 45 below.

g(h,v)=scale_{—}n×G(h,v−1)+scale_{—}s×G(h,v+1)+scale_{—}w×G(h−1,v)+scale_{—}e×G(h+1,v)+scale_{—}n×(R(h,v)−R(h,v−2))×scly+scale_{—}s×(R(h,v)−R(h,v+2))×scly+scale_{—}w×(R(h,v)−R(h−2,v))×scly+scale_{—}e×(R(h,v)−R(h+2,v))×scly Expression 45

Also here, scly denotes a coefficient for adjusting an effect of a correction item and is set to, for example, a value satisfying the following expression.

1≧scly.

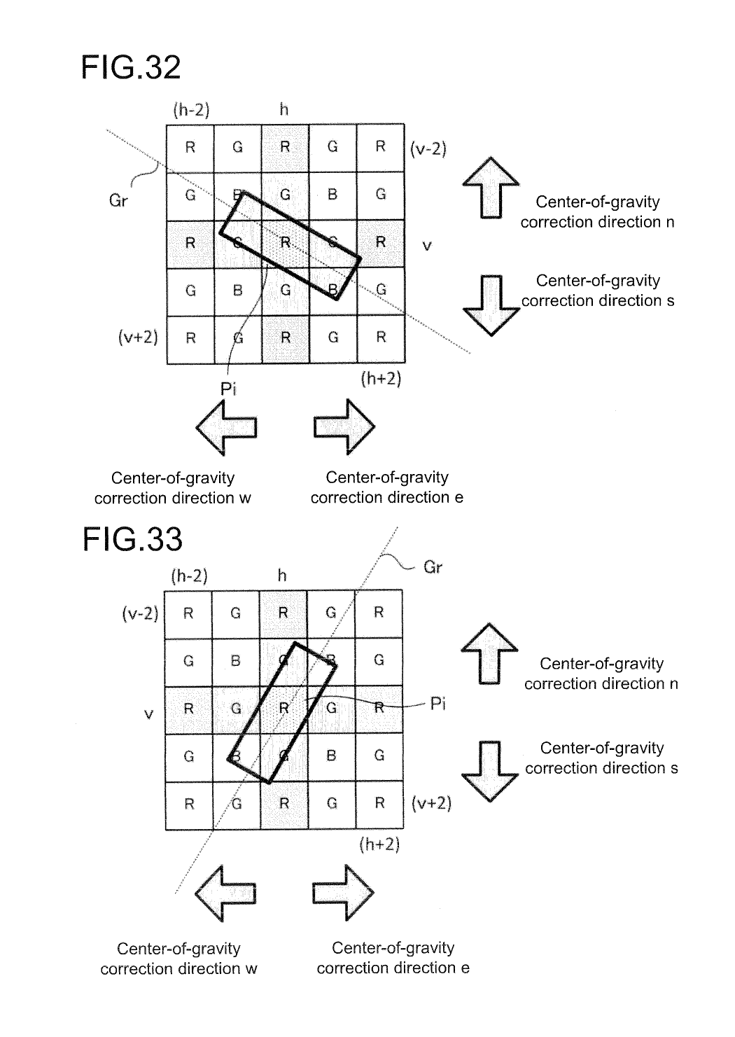

FIG. 32 is a diagram showing an example of a case where the boundary direction is 150°. Also regarding the estimated 150°-boundary direction, the positions of pixels used for interpolation are those of the upper, lower, left, and right G-pixels adjacent to the target pixel Pi. Thus, the positions of pixels used for interpolation are the same as those in the case of the estimated 30°-boundary direction. Further, as shown in FIG. 32, portions in which those pixels (h, v−1), (h−1, v), (h, v+1), and (h+1, v) and the boundary overlap with each other have almost the same area as that in the case where the boundary direction is 30° as shown in FIG. 31. Thus, also in the case where the boundary direction is determined to be 150°, the interpolation value can be calculated using the same calculation formula as that in the case of the 30°-boundary direction.

### (3-3-6. Interpolation Value Calculation Method in Estimated 60°-Boundary Direction)

Next, an interpolation value calculation method in the estimated 60°-boundary direction will be described with reference to FIG. 33. Also regarding the estimated 60°-boundary direction, as shown in FIG. 33, the pixel values G (h, v−1), G (h−1, v), (h+1, v), and G (h, v+1) of the upper, lower, left, and right G-pixels adjacent to the target pixel Pi are used for calculating the interpolation value. The interpolation value g (h, v) can be calculated using Expression 36 the same as the correction value calculation formula in the estimated 30°-boundary direction.

A calculation method for “dif_n”, “dif_s”, “dif_w”, and “dif_e” indicating the amount of deviation of the center of gravity is also the same as that in the case of the estimated 30°-boundary direction. A different point from the interpolation value calculation method in estimated 30°-boundary direction is in the magnitude relationship between the values of the coefficient scl0 and the coefficient scl1. In the estimated 60°-boundary direction, each of the values of the coefficient scl0 and the coefficient scl1 is set to satisfy the following expression.

scl0>scl1.

With such setting, the allocation of “scale_n” and “scale_s” in Expression 36 can be set to be larger than the allocation of “scale_w” and “scale_e.” That is, a weight set to each of the pixel value G (h+1, v) of G on the right-hand side of the target pixel Pi and the pixel value G (h−1, v) of G on the left-hand side can be made larger than a weight set to each of the pixel value G (h, v−1) of G on the upper side and the pixel value G (h, v+1) of G on the lower side.

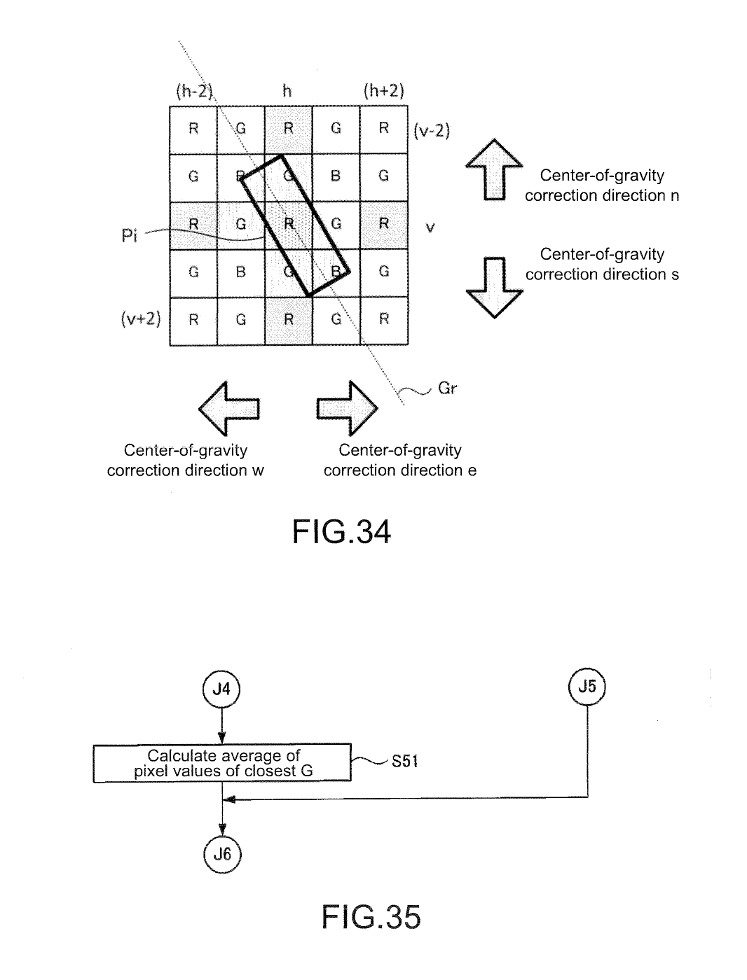

FIG. 34 is a diagram showing an example of a case where the boundary direction is 120°. Also regarding the estimated 120°-boundary direction, the positions of the pixels used for interpolation are those of the upper, lower, left, and right G pixels adjacent to the target pixel Pi. The positions of the pixels used for interpolation are the same as those in the case of the estimated 60°-boundary direction. Further, as shown in FIG. 34, a portion in which those pixels (h, v−1), (h−1, v), (h, v+1), and (h+1, v) and the boundary overlap with each other has almost the same area as that in the case where the boundary direction shown in FIG. 33 is 60°. Thus, also in the case where the boundary direction is determined to be 120°, the interpolation value can be calculated using the same calculation formula as that in the case of the 60°-boundary direction.

(3-3-7. Interpolation Value Calculation Method if Boundary does not Correspond to any One of Estimated Boundary Directions)

Next, an interpolation value calculation method if the boundary does not correspond to any one of the estimated boundary directions will be described with reference to a flowchart of FIG. 35. The flowchart of FIG. 35 shows processing after the connector J4 in the flowchart shown in FIG. 23. In the flowchart shown in FIG. 23, the processing proceeds to the connector J4 in the case where the boundary direction does not belong to either one of the first group and the second group.

In the flowchart shown in FIG. 35, an average value of the pixel values of the upper, lower, left, and right G-pixels adjacent to the target pixel Pi is set as the interpolation value for the target pixel Pi (Step S51). That is, the interpolation value g (h, v) is calculated using Expression 27 above.

Note that, even if the boundary direction does not correspond to any one of the estimated boundary directions, correction of luminance can be performed in the case where the pixel value of the target pixel Pi is the extreme value as compared to the pixel values of the pixels that are closest to the target pixel Pi and have the same color component as that of the target pixel Pi. In this case, the interpolation value g (h, v) only needs to be calculated using Expression 28 above.

### [3-4. Exemplary Interpolation Processing of Color Component by Interpolation Value Calculation Unit]

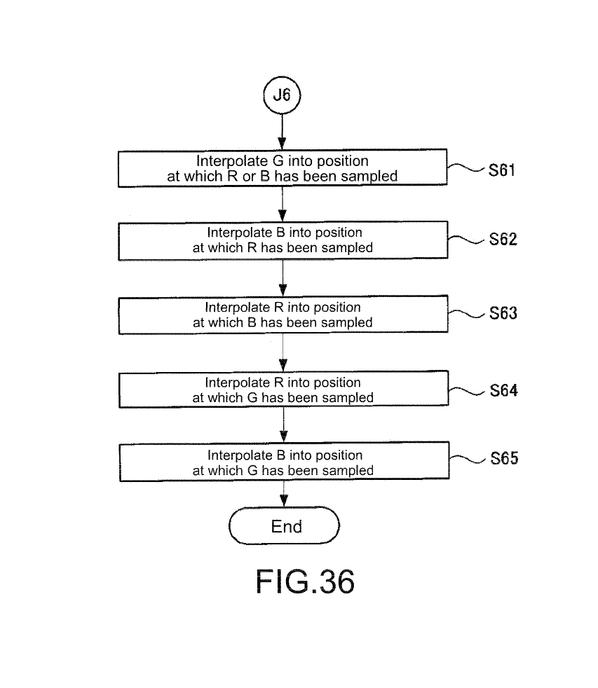

Next, exemplary interpolation processing of color components by the interpolation value calculation unit 503 (cf. FIG. 2) that follows a connector J6 in FIG. 35 will be described with reference to a flowchart of FIG. 36. In the interpolation value calculation unit 503, after the interpolation value g is calculated by the process as described above, the interpolation processing of other color components is performed by the following procedure. A traditionally used process is applicable to this processing as it is.

First, G is interpolated into a position at which R or B has been sampled (Step S61). That is, the interpolation value g (h, v) obtained by the above-mentioned processes is interpolated into the position at which R or B has been sampled. Next, the B-pixel value is interpolated into a position at which R has been sampled (Step S62). The R-pixel value is interpolated into a position at which B has been sampled (Step S63). Then, the R-pixel value is interpolated into a position at which G has been sampled (Step S64). The B-pixel value is interpolated into a position at which G has been sampled (Step S65).

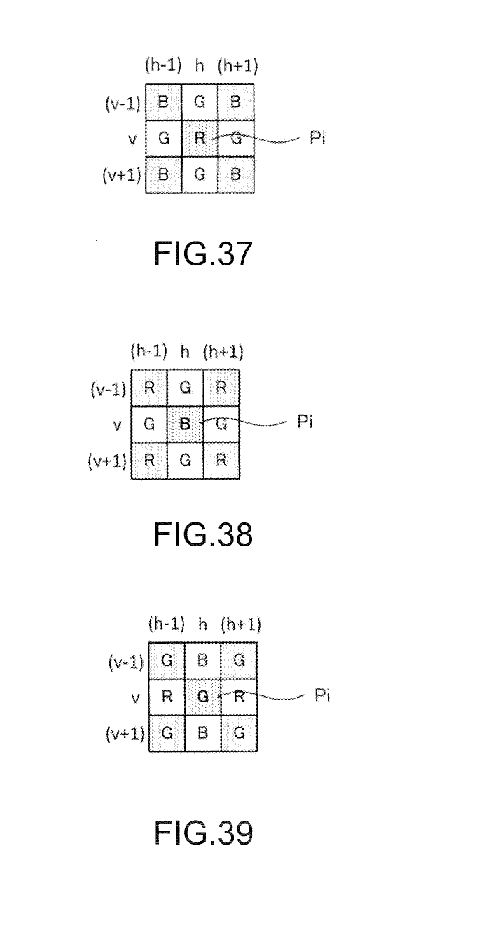

The processing of interpolating the B-pixel value into the position at which R has been sampled in Step S62 will be described with reference to FIG. 37. In the interpolation value calculation for B with respect to the position of R, a difference average value between B-pixel values at positions of (h−1, v−1) on the upper left-hand side, (h+1, v−1) on the upper right-hand side, (h−1, v+1) on the lower left-hand side, and (h+1, v+1) on the lower right-hand side of the target pixel Pi shown in FIG. 37 and the interpolation values g already calculated at the same positions is first calculated. Then, the interpolation value g is added to the calculated difference average value. When the interpolation value to be calculated is expressed by an interpolation value b (h, v), the interpolation value b (h, v) can be calculated using Expression 46 below.

b(h,v)=(B(h−1,v−1)−g(h−1,v−1)+B(h+1,v−1)−g(h+1,v−1)+B(h−1,v+1)−g(h−1,v+1)+B(h+1,v+1)−g(h+1,v+1))/4+g(h,v) Expression 46

Next, the processing of interpolating the R-pixel value into the position at which B has been sampled in Step S63 will be described with reference to FIG. 38. In the interpolation value calculation of R with respect to the position of B, a difference average value between each of R-pixel values at the positions of (h−1, v−1) on the upper left-hand side, (h+1, v−1) on the upper right-hand side, (h−1, v+1) on the lower left-hand side, and (h+1, v+1) on the lower right-hand side of the target pixel Pi shown in FIG. 38 and the interpolation values g already calculated at the same positions is first calculated. Then, the interpolation value g is added to the calculated difference average value. When the interpolation value to be calculated is expressed by an interpolation value r (h, v), the interpolation value r (h, v) can be calculated using Expression 47 below.

r(h,v)=(R(h−1,v−1)−g(h−1,v−1)+R(h+1,v−1)−g(h+1,v−1)+R(h−1,v+1)−g(h−1,v+1)+R(h+1,v+1)−g(h+1,v+1))/4+g(h,v) Expression 47

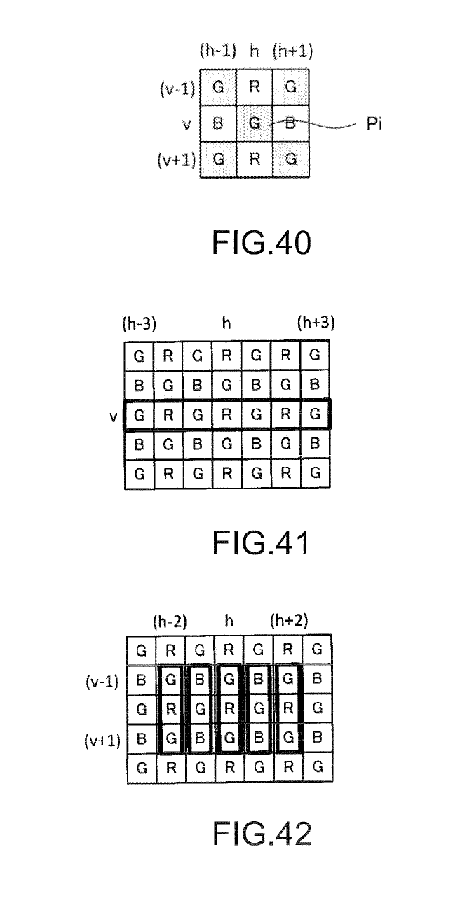

Next, the processing of interpolating the R-pixel value into the position at which G has been sampled in Step S64 will be described with reference to FIGS. 39 and 40. In the interpolation value calculation of R at the position of G, a difference average value between each of R-pixel values at the positions of (h, v−1) on the upper side, (h−1, v) on the left-hand side, (h+1, v) on the right-hand side, and (h, v+1) on the lower side of the target pixel Pi shown in FIG. 39 or an interpolation value r calculated using Expression 47 and the interpolation values g already calculated at the same positions is first calculated. Then, the interpolation value g is added to the calculated difference average value. When the interpolation value to be calculated is expressed by an interpolation value r′ (h, v), the interpolation value r′ (h, v) can be calculated using Expression 48 below. In Expression 48, the characters for the R-pixel value and the interpolation value r calculated using Expression 47 are unified, and r is used. As shown in FIG. 39, in the case where the R-pixel value is located at (h−1, v) on the left-hand side and (h+1, v) on the right-hand side of the target pixel Pi, r (h−1, v)=R (h−1, v), r (h+1, v)=R (h+1, v). As shown in FIG. 40, in the case where the R-pixel value is at (h, v−1) on the upper side and (h, v+1) on the lower side of the target pixel Pi, r (h, v−1)=R (h, v−1), r (h, v+1)=R (h, v+1).

r′(h,v)=(r(h,v−1)−g(h,v−1)+r(h−1,v)−g(h−1,v)+r(h+1,v)−g(h+1,v)+r(h,v+1)−g(h,v+1))/4+g(h,v) Expression 48

Next, the processing of interpolating the B-pixel value into the position at which G has been sampled in Step S65 will be described also with reference to FIGS. 39 and 40. In the interpolation value calculation of B at the position of G, a difference average value between each of the B-pixel values at positions of (h, v−1) on the upper side, (h−1, v) on the left-hand side, (h+1, v) on the right-hand side, and (h, v+1) on the lower side of the target pixel Pi shown in FIG. 40 or an interpolation value b calculated using Expression 46 and the interpolation values g already calculated at the same positions is first calculated. Then, the interpolation value g is added to the calculated difference average value. When the interpolation value to be calculated is expressed by an interpolation value b′ (h, v), the interpolation value b′ (h, v) can be calculated using Expression 49 below. In Expression 49, the characters for the B-pixel value and the interpolation value b calculated using Expression 46 are unified, and b is used. As shown in FIG. 40, in the case where the B-pixel value is located at (h−1, v) on the left-hand side and (h+1, v) on the right-hand side of the target pixel Pi, b (h−1, v)=B (h−1, v) and b (h+1, v)=B (h+1, v). As in FIG. 39, in the case where the B-pixel value is at (h, v−1) on the upper side and (h, v+1) on the lower side of the target pixel Pi, b (h, v−1)=B (h, v−1) and b (h, v+1)=B (h, v+1).

b′(h,v)=(b(h,v−1)−g(h,v−1)+b(h−1,v)−g(h−1,v)+b(h+1,v)−g(h+1,v)+b(h,v+1)−g(h,v+1))/4+g(h,v) Expression 49

According to the above-mentioned embodiment, the boundary direction is determined using on information on the first direction A_a1 in which the pixel change amount is smallest among the estimated boundary directions and the second direction A_c1 in which the pixel change amount is largest among the directions perpendicular to the estimated boundary directions. Then, the interpolation value is calculated by a calculation method corresponding to the estimated boundary direction in which the boundary is determined to be present. Using the interpolation value, interpolation is performed. That is, also if boundaries are present in various directions including oblique directions, the interpolation processing is performed using the calculated interpolation value by a calculation method corresponding to those directions. Therefore, it is possible to suppress generation of false color in the boundary direction.

Further, according to the above-mentioned embodiment, in the case where the first direction A_a1 and the third direction A_r1 are the estimated boundary directions in the first group that are adjacent to each other, it is determined that the boundary is present in a (fourth) estimated boundary direction in the second group that is located at a position sandwiched between the first direction and the third direction. The first direction A_a1 and the third direction A_r1 can be the estimated boundary directions in the first group that are adjacent to each other if either one of the first direction A_a1 and the third direction A_r1 is 0° being the first estimated boundary direction or 90° being the second estimated boundary direction and the other is 45° or 135° being the third estimated boundary direction.

In this manner, also if boundaries are present in various directions of 30°, 60°, 120°, and 150° being the (fourth) estimated boundary directions in the second group, the boundaries can be detected. Therefore, generation of false color in those directions can be suppressed.

Further, the boundaries in each of directions of 30°, 60°, 120°, and 150° being the (fourth) estimated boundary directions in the second group can be detected without calculating the pixel change amount, the amount of calculation of the interpolation processing can be reduced. With this, a time necessary for the interpolation processing can be prevented from increasing.

Further, the amount of calculation can be reduced, and hence a circuit scale can also be reduced. A circuit having a size corresponding to the interpolation processor can also be installed into an integrated circuit (IC). In addition, not only installation into the IC but also implementation on firmware or a general purpose graphics processing unit (GPGPU) under severe constraints of code quantity can be performed.

Further, according to the above-mentioned embodiment, if the center of gravity of the boundary is deviated from the center of the target pixel, the interpolation value is calculated using a correction coefficient corresponding to the amount of deviation. Therefore, generation of false color due to deviation of the center of gravity of the boundary can also be suppressed.

Further, according to the above-mentioned embodiment, in the case where the target pixel has the extreme value as compared to pixel values of surrounding pixels that are close to the target pixel and have the same color component as that of the target pixel, the interpolation value is calculated using a correction value corresponding to a difference between the pixel value of the target pixel and each of the pixel values of the surrounding pixels that are close to the target pixel and have the same color component as that of the target pixel. Therefore, generation of false color due to luminance can also be suppressed.

### 4. Various Modified Examples

Note that the number of combinations of pixels for which a difference is to be calculated for calculating “dif_along_” or “dif_cross_” used for determining the boundary direction in the above-mentioned embodiment is merely an example. By increasing the number, the determination accuracy of the boundary direction may be increased.

The pixel change amount in the estimated 0°-boundary direction is exemplified. For example, as shown in FIG. 41, an area of pixels used for calculating the pixel change amount in the estimated 0°-boundary direction dif_along_{—}0 may be extended to (h−3) on the left-hand side and (h+3) on the right-hand side and the number of combinations for calculating the difference value may be increased to 5. The pixel change amount dif_along_{—}0 in this case can be calculated using Expression 50 below.

dif_along_{—}0=(abs(G(h−3,v)−G(h−1,v))+abs(R(h−2,v)−R(h,v))+abs(G(h−1,v)−G(h+1,v))+abs(R(h,v)−R(h+2,v))+abs(G(h+1,v)−G(h+3,v)))/5 Expression 50

Regarding the pixel change amount in the direction perpendicular to the estimated 0°-boundary direction dif_cross_{—}0, as shown in FIG. 42, difference values between (v−1) and (v+1) are calculated at five positions from the position of (h−2) to the position of (h+2) in the horizontal direction. The pixel change amount dif_cross_{—}0 in this case can be calculated using Expression 51 below.

dif_cross_{—}0=(abs(G(h−2,v−1)−G(h−2,v+1))+abs(B(h−1,v−1)−B(h−1,v+1))+abs(G(h,v−1)−G(h,v+1))+abs(B(h+1,v−1)−B(h+1,v+1))+abs(G(h+2,v−1)−G(h+2,v+1)))/5 Expression 51

Further, in the above-mentioned embodiment, the example using the first direction A_a1 being a direction having the minimum value among the pixel change amounts calculated in the estimated boundary directions, the second direction A_c1 being a direction having the maximum value among the pixel change amounts calculated in the directions perpendicular to estimated boundary directions, and the third direction A_r1 perpendicular to A_c1 has been shown. However, the present disclosure is not limited thereto. A direction having a second smallest value among the calculated pixel change amounts in the estimated boundary directions and a direction having a second largest value among the pixel change amounts in directions perpendicular to the boundary may also be referred to. With this configuration, the determination accuracy of the boundary direction can be further increased.

Further, in the above-mentioned embodiment, for example, as in the example shown in FIGS. 8A and 8B, also in the case where a duplicated portion is present in the pixel change amount calculation areas Arc for calculating the pixel change amount, the pixel change amounts are individually calculated in the respective pixel change amount calculation areas Arc. However, considering the duplication portion, results may be stored by performing only minimum necessary difference calculation in advance, and the stored results may be referred to upon summing of change amounts.

Further, in the above embodiment, the example in which the image processing apparatus according to the embodiment of the present disclosure is applied to the imaging apparatus has been described. The image processing apparatus according to the embodiment of the present disclosure is not limited thereto. The image processing apparatus according to the embodiment of the present disclosure can be applied also to the image processing apparatus without the image sensor or the like, the image processing apparatus loading an image signal obtained by the imaging apparatus and performing image processing.

Further, a series of processing in the above-mentioned embodiment can be executed by hardware. Alternatively, the series of processing may also be executed by software. When the series of processing is executed by the software, the series of processing can be executed by a computer with dedicated hardware incorporating a program configuring the software or by a computer installing a program for executing various functions. For example, a program configuring desired software only needs to be installed into a general-purpose personal computer or the like to execute the program.

Further, a recording medium storing a program code of software for realizing functions of the above-mentioned embodiment may be supplied to a system or an apparatus. It is needless to say that the functions can be realized also by a computer (or control apparatus such as CPU) of the system or the apparatus reading out and executing the program code stored in the recording medium.

Examples of the recording medium for supplying the program code in this case include a flexible disc, a hard disk, an optical disc, a magneto-optical disc, a CD-ROM, a CD-R, a magnetic tape, a non-volatile memory card, and a ROM.

Further, the functions of the above-mentioned embodiment are realized by executing the program code read by the computer. Additionally, according to instructions of the program code, an OS or the like operating on the computer executes part or entire of actual processing. The processing may realize the functions of the above-mentioned embodiment.

It should be noted that the present disclosure may also take the following configurations.

(1) An image processing apparatus, including:

a pixel change amount calculation unit configured to calculate first pixel change amounts and second pixel change amounts by using a pixel signal outputted by an image sensor configured to photoelectrically convert light passing through a color filter including first color filters and second color filters and output the light as the pixel signal, the first color filters each including a first color component and being arranged in a checkerboard pattern, the second color filters each including a second color component different from the first color component and being arranged at positions other than the positions at which the first color filters are arranged in the checkerboard pattern, the first pixel change amounts being change amounts of pixel values at least in a first estimated boundary direction, a second estimated boundary direction, and a third estimated boundary direction out of estimated boundary directions in each of which a boundary of adjacent pixels having pixel values largely different from each other is estimated to be present, the second pixel change amounts being change amounts of pixel values in directions perpendicular to the first to third estimated boundary directions, the first estimated boundary direction being a horizontal direction in an arrangement direction of the pixels, the second estimated boundary direction being a vertical direction in the arrangement direction of the pixels, the third estimated boundary direction extending in a line that almost halves an angle formed by the first estimated boundary direction and the second estimated boundary direction;

a boundary direction determination unit configured to determine a boundary direction in which the boundary is present by using information on the first pixel change amounts calculated in the first to third estimated boundary directions and the second pixel change amounts calculated in the directions perpendicular to the first to third estimated boundary directions;

an interpolation value calculation unit configured to calculate an interpolation value corresponding to the boundary direction based on a result of the determination of the boundary direction determination unit; and

an interpolation processor configured to interpolate the first color component into a target pixel including the second color component by using the interpolation value calculated in the interpolation value calculation unit.

(2) The image processing apparatus according to Item (1), in which

the boundary direction determination unit is configured to
set a direction in which the first pixel change amount has a minimum value among the first to third estimated boundary directions as a first direction,
set a direction in which the second pixel change amount is a maximum value among the first to third estimated boundary directions as a second direction, and
determine, based on a relationship between the first direction and the second direction, the boundary direction.
   (3) The image processing apparatus according to Item (2), in which

the boundary direction determination unit is configured to
set, when the first direction and the second direction are different from each other, a direction orthogonal to the second direction as a third direction, and
determines, if, out of the first direction and the third direction, one is one of the first estimated boundary direction and the second estimated boundary direction, the other is the third estimated boundary direction, and the first direction and the third direction are adjacent to each other, that the boundary direction is a fourth estimated boundary direction between the first direction and the third direction adjacent to each other.
   (4) The image processing apparatus according to Item (2) or (3), in which

the boundary direction determination unit determines, if the first direction and the second direction are orthogonal to each other, that the boundary direction corresponds to any one of the first estimated boundary direction, the second estimated boundary direction, and the third estimated boundary direction.

(5) The image processing apparatus according to Item (3) or (4), in which

the interpolation value calculation unit is configured to
compare, if the boundary direction determination unit determines that the boundary direction is one of the third estimated boundary direction and the fourth estimated boundary direction, a pixel value of each of pixels that are closest to the target pixel and have the same color component as that of the target pixel with a pixel value of the target pixel, and
determine, if the pixel value of the target pixel is not one of the maximum value and the minimum value, that the boundary passes through a position deviated from a center of the target pixel, and calculate the interpolation value by weighted averaging using a weight coefficient corresponding to the amount of deviation of the position of the boundary from the center of the target pixel.
   (6) The image processing apparatus according to any one of Items (3) to (5), in which

the interpolation value calculation unit is configured to calculate the interpolation value by averaging the pixel values of surrounding pixels that are closest to the target pixel if the boundary direction determination unit determines that the boundary direction does not correspond to any one of the first to fourth estimated boundary directions, if the boundary direction determination unit determines that the boundary direction is one of the first estimated boundary direction and the second estimated boundary direction, or if the boundary direction determination unit determines that the boundary direction is the third estimated boundary direction and a pixel value of the target pixel is one of the maximum value and the minimum value as compared to the pixel values of the pixels that are closest to the target pixel and have the same color component as that of the target pixel.

(7) The image processing apparatus according to any one of Items (1) to (6), in which

the interpolation value calculation unit is configured to calculate the interpolation value corresponding to a difference between a pixel value of the target pixel and each of the pixel values of the pixels that are closest to the target pixel and have the same color component as that of the target pixel if the boundary direction determination unit determines that the boundary direction does not correspond to any one of the first to fourth estimated boundary directions, if the boundary direction determination unit determines that the boundary direction is one of the first estimated boundary direction and the second estimated boundary direction and the pixel value of the target pixel is one of the maximum value and the minimum value as compared to the pixel values of the pixels that are closest to the target pixel and have the same color component as that of the target pixel, or if the boundary direction determination unit determines that the boundary direction is the third estimated boundary direction and the pixel value of the target pixel is one of the maximum value and the minimum value as compared to the pixel values of the pixels that are closest to the target pixel and have the same color component as that of the target pixel.

(8) The image processing apparatus according to any one of Items (1) to (7), in which

the third estimated boundary direction includes a 45°-direction and a 135°-direction with the first estimated boundary direction being set to 0°,

the fourth estimated boundary direction includes a 30°-direction, a 60°-direction, a 120°-direction, and a 150°-direction, and

the interpolation value calculation unit is configured to use the same interpolation value calculation method in the 30°-direction and the 150°-direction and to use the same interpolation value calculation method in the 60°-direction and the 120°-direction.

(9) An image processing method, including:

calculating first pixel change amounts and second pixel change amounts by using a pixel signal outputted by an image sensor configured to photoelectrically convert light passing through a color filter including first color filters and second color filters and output the light as the pixel signal, the first color filters each including a first color component and being arranged in a checkerboard pattern, the second color filters each including a second color component different from the first color component and being arranged at positions other than the positions at which the first color filters are arranged in the checkerboard pattern, the first pixel change amounts being change amounts of pixel values at least in a first estimated boundary direction, a second estimated boundary direction, and a third estimated boundary direction out of estimated boundary directions in each of which a boundary of adjacent pixels having pixel values largely different from each other is estimated to be present, the second pixel change amounts being change amounts of pixel values in directions perpendicular to the first to third estimated boundary directions, the first estimated boundary direction being a horizontal direction in an arrangement direction of the pixels, the second estimated boundary direction being a vertical direction in the arrangement direction of the pixels, the third estimated boundary direction extending in a line that almost halves an angle formed by the first estimated boundary direction and the second estimated boundary direction;

determining a boundary direction in which the boundary is present by using information on the calculated first pixel change amounts and the second pixel change amounts calculated in the directions perpendicular to the first to third estimated boundary directions;

calculating an interpolation value corresponding to the boundary direction based on a result of the determination; and

interpolating the first color component into a target pixel including the second color component by using the calculated interpolation value.

(10) A program that causes a computer to execute:

calculating first pixel change amounts and second pixel change amounts by using a pixel signal outputted by an image sensor configured to photoelectrically convert light passing through a color filter including first color filters and second color filters and output the light as the pixel signal, the first color filters each including a first color component and being arranged in a checkerboard pattern, the second color filters each including a second color component different from the first color component and being arranged at positions other than the positions at which the first color filters are arranged in the checkerboard pattern, the first pixel change amounts being change amounts of pixel values at least in a first estimated boundary direction, a second estimated boundary direction, and a third estimated boundary direction out of estimated boundary directions in each of which a boundary of adjacent pixels having pixel values largely different from each other is estimated to be present, the second pixel change amounts being change amounts of pixel values in directions perpendicular to the first to third estimated boundary directions, the first estimated boundary direction being a horizontal direction in an arrangement direction of the pixels, the second estimated boundary direction being a vertical direction in the arrangement direction of the pixels, the third estimated boundary direction extending in a line that almost halves an angle formed by the first estimated boundary direction and the second estimated boundary direction;

determining a boundary direction in which the boundary is present by using information on the calculated first pixel change amounts and the second pixel change amounts calculated in the directions perpendicular to the first to third estimated boundary directions;

calculating an interpolation value corresponding to the boundary direction based on a result of the determination; and

interpolating the first color component into a target pixel including the second color component by using the calculated interpolation value.

The present disclosure contains subject matter related to that disclosed in Japanese Priority Patent Application JP 2012-104522 filed in the Japan Patent Office on May 1, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
a pixel change amount calculation unit configured to calculate first pixel change amounts and second pixel change amounts by using a pixel signal outputted by an image sensor configured to photoelectrically convert light passing through a color filter including first color filters and second color filters and output the light as the pixel signal, the first color filters each including a first color component and being arranged in a checkerboard pattern, the second color filters each including a second color component different from the first color component and being arranged at positions other than the positions at which the first color filters are arranged in the checkerboard pattern, the first pixel change amounts being change amounts of pixel values at least in a first estimated boundary direction, a second estimated boundary direction, and a third estimated boundary direction out of estimated boundary directions in each of which a boundary of adjacent pixels having pixel values largely different from each other is estimated to be present, the second pixel change amounts being change amounts of pixel values in directions perpendicular to the first to third estimated boundary directions, the first estimated boundary direction being a horizontal direction in an arrangement direction of the pixels, the second estimated boundary direction being a vertical direction in the arrangement direction of the pixels, the third estimated boundary direction extending in a line that almost halves an angle formed by the first estimated boundary direction and the second estimated boundary direction;
a boundary direction determination unit configured to determine a boundary direction in which the boundary is present by using information on the first pixel change amounts calculated in the first to third estimated boundary directions and the second pixel change amounts calculated in the directions perpendicular to the first to third estimated boundary directions;
an interpolation value calculation unit configured to calculate an interpolation value corresponding to the boundary direction based on a result of the determination of the boundary direction determination unit; and
an interpolation processor configured to interpolate the first color component into a target pixel including the second color component by using the interpolation value calculated in the interpolation value calculation unit.

2. The image processing apparatus according to claim 1, wherein
the boundary direction determination unit is configured to
set a direction in which the first pixel change amount has a minimum value among the first to third estimated boundary directions as a first direction,
set a direction in which the second pixel change amount is a maximum value among the first to third estimated boundary directions as a second direction, and
determine, based on a relationship between the first direction and the second direction, the boundary direction.

3. The image processing apparatus according to claim 2, wherein
the boundary direction determination unit is configured to
set, when the first direction and the second direction are different from each other, a direction orthogonal to the second direction as a third direction, and
determines, if, out of the first direction and the third direction, one is one of the first estimated boundary direction and the second estimated boundary direction, the other is the third estimated boundary direction, and the first direction and the third direction are adjacent to each other, that the boundary direction is a fourth estimated boundary direction between the first direction and the third direction adjacent to each other.

4. The image processing apparatus according to claim 3, wherein
the boundary direction determination unit determines, if the first direction and the second direction are orthogonal to each other, that the boundary direction corresponds to any one of the first estimated boundary direction, the second estimated boundary direction, and the third estimated boundary direction.

5. The image processing apparatus according to claim 3, wherein
the interpolation value calculation unit is configured to
compare, if the boundary direction determination unit determines that the boundary direction is one of the third estimated boundary direction and the fourth estimated boundary direction, a pixel value of each of pixels that are closest to the target pixel and have the same color component as that of the target pixel with a pixel value of the target pixel, and
determine, if the pixel value of the target pixel is not one of the maximum value and the minimum value, that the boundary passes through a position deviated from a center of the target pixel, and calculate the interpolation value by weighted averaging using a weight coefficient corresponding to the amount of deviation of the position of the boundary from the center of the target pixel.

6. The image processing apparatus according to claim 3, wherein
the interpolation value calculation unit is configured to calculate the interpolation value by averaging the pixel values of surrounding pixels that are closest to the target pixel if the boundary direction determination unit determines that the boundary direction does not correspond to any one of the first to fourth estimated boundary directions, if the boundary direction determination unit determines that the boundary direction is one of the first estimated boundary direction and the second estimated boundary direction, or if the boundary direction determination unit determines that the boundary direction is the third estimated boundary direction and a pixel value of the target pixel is one of the maximum value and the minimum value as compared to the pixel values of the pixels that are closest to the target pixel and have the same color component as that of the target pixel.

7. The image processing apparatus according to claim 3, wherein
the interpolation value calculation unit is configured to calculate the interpolation value corresponding to a difference between a pixel value of the target pixel and each of the pixel values of the pixels that are closest to the target pixel and have the same color component as that of the target pixel if the boundary direction determination unit determines that the boundary direction does not correspond to any one of the first to fourth estimated boundary directions, if the boundary direction determination unit determines that the boundary direction is one of the first estimated boundary direction and the second estimated boundary direction and the pixel value of the target pixel is one of the maximum value and the minimum value as compared to the pixel values of the pixels that are closest to the target pixel and have the same color component as that of the target pixel, or if the boundary direction determination unit determines that the boundary direction is the third estimated boundary direction and the pixel value of the target pixel is one of the maximum value and the minimum value as compared to the pixel values of the pixels that are closest to the target pixel and have the same color component as that of the target pixel.

8. The image processing apparatus according to claim 3, wherein
the third estimated boundary direction includes a 45°-direction and a 135°-direction with the first estimated boundary direction being set to 0°,
the fourth estimated boundary direction includes a 30°-direction, a 60°-direction, a 120°-direction, and a 150°-direction, and
the interpolation value calculation unit is configured to use the same interpolation value calculation method in the 30°-direction and the 150°-direction and to use the same interpolation value calculation method in the 60°-direction and the 120°-direction.

9. An image processing method, comprising:
calculating first pixel change amounts and second pixel change amounts by using a pixel signal outputted by an image sensor configured to photoelectrically convert light passing through a color filter including first color filters and second color filters and output the light as the pixel signal, the first color filters each including a first color component and being arranged in a checkerboard pattern, the second color filters each including a second color component different from the first color component and being arranged at positions other than the positions at which the first color filters are arranged in the checkerboard pattern, the first pixel change amounts being change amounts of pixel values at least in a first estimated boundary direction, a second estimated boundary direction, and a third estimated boundary direction out of estimated boundary directions in each of which a boundary of adjacent pixels having pixel values largely different from each other is estimated to be present, the second pixel change amounts being change amounts of pixel values in directions perpendicular to the first to third estimated boundary directions, the first estimated boundary direction being a horizontal direction in an arrangement direction of the pixels, the second estimated boundary direction being a vertical direction in the arrangement direction of the pixels, the third estimated boundary direction extending in a line that almost halves an angle formed by the first estimated boundary direction and the second estimated boundary direction;
determining a boundary direction in which the boundary is present by using information on the calculated first pixel change amounts and the second pixel change amounts calculated in the directions perpendicular to the first to third estimated boundary directions;
calculating an interpolation value corresponding to the boundary direction based on a result of the determination; and
interpolating the first color component into a target pixel including the second color component by using the calculated interpolation value.

10. A program that causes a computer to execute:
calculating first pixel change amounts and second pixel change amounts by using a pixel signal outputted by an image sensor configured to photoelectrically convert light passing through a color filter including first color filters and second color filters and output the light as the pixel signal, the first color filters each including a first color component and being arranged in a checkerboard pattern, the second color filters each including a second color component different from the first color component and being arranged at positions other than the positions at which the first color filters are arranged in the checkerboard pattern, the first pixel change amounts being change amounts of pixel values at least in a first estimated boundary direction, a second estimated boundary direction, and a third estimated boundary direction out of estimated boundary directions in each of which a boundary of adjacent pixels having pixel values largely different from each other is estimated to be present, the second pixel change amounts being change amounts of pixel values in directions perpendicular to the first to third estimated boundary directions, the first estimated boundary direction being a horizontal direction in an arrangement direction of the pixels, the second estimated boundary direction being a vertical direction in the arrangement direction of the pixels, the third estimated boundary direction extending in a line that almost halves an angle formed by the first estimated boundary direction and the second estimated boundary direction;
determining a boundary direction in which the boundary is present by using information on the calculated first pixel change amounts and the second pixel change amounts calculated in the directions perpendicular to the first to third estimated boundary directions;
calculating an interpolation value corresponding to the boundary direction based on a result of the determination; and
interpolating the first color component into a target pixel including the second color component by using the calculated interpolation value.
